(19) United States
(12) Patent Application Publication
(10) Pub. No.: US 2012/0300301 A1
(43) Pub. Date: Nov. 29, 2012

(54) DIFFRACTION-GRATING LENS, AND IMAGING OPTICAL SYSTEM AND IMAGING DEVICE USING SAID DIFFRACTION-GRATING LENS

(75) Inventors: Takamasa Ando, Osaka (JP); Tsuguhiro Korenaga, Osaka (JP)

(73) Assignee: PANASONIC CORPORATION, Osaka (JP)

(21) Appl. No.: 13/575,781

(22) PCT Filed: Dec. 9, 2011
(86) PCT No.: PCT/JP2011/006881

§ 371 Date: Jul. 27, 2012

(30) Foreign Application Priority Data
Dec. 10, 2010 (JP) 2010-276248

(51) Int. Cl. G02B 27/44; G02B 5/18

(52) U.S. Cl. 359/565

(57) ABSTRACT

An imaging optical system according to the present invention includes: at least one diffraction grating lens with a diffraction grating that is made up of q diffraction ring zones; and a stop. A surface of the at least one diffraction grating lens that has the diffraction grating is a lens surface that is located closest to the stop. Supposing the respective widths of diffraction ring zones that are located first, second, (m−1)^{th} and m^{th} closest to the optical axis of the optical system are identified by P₁, P₂, Pₘ₋₁ and Pₘ, at least one m that falls within the range 3<m≦q satisfies the following Inequality (3):

$$k = \frac{( \frac{1}{{P}_{m - 1}} \cdot \frac{{P}_{m - 1} - {P}_{m}}{{P}_{m - 1} \cdot {P}_{m}} )}{( \frac{1}{{P}_{1}} \cdot \frac{{P}_{1} - {P}_{2}}{{P}_{1} \cdot {P}_{2}} )} > 1.6 \qquad ( 3 )$$

### TECHNICAL FIELD

The present invention relates to a diffraction grating lens (or diffractive optical element) that makes incoming light either converge or diverge by utilizing a diffraction phenomenon and also relates to an imaging optical system and image capture device that use such a lens.

### BACKGROUND ART

It is widely known that a diffraction grating lens, of which the surface defines diffraction ring zones, can correct various lens aberrations such as field curvature and chromatic aberration (which is a shift of a focal point according to the wavelength) very well. This is because a diffraction grating has distinct properties, including inverse dispersion and anomalous dispersion, and also has excellent ability to correct the chromatic aberration. If a diffraction grating is used in an imaging optical system, the same performance is realized by using a smaller number of lenses compared to a situation where an imaging optical system is made up of only aspheric lenses. As a result, the manufacturing cost can be cut down, the optical length can be shortened, and the overall size can be reduced.

FIG. 30 shows how to derive the diffraction grating surface shape of a diffraction grating lens. A diffraction grating lens is designed by either a phase function method or a high refractive index method in most cases. Although a designing process that uses the phase function method will be described as an example, the final result will be the same even if the design process is carried out by the high refractive index method. A diffraction grating lens is obtained as a combination of the aspheric shape that is the basic shape (see FIG. 30(a)) and a diffraction grating shape to be determined by the phase function (see FIG. 30(b)). The phase function is represented by the following Equation (1):

$$φ ( r ) = \frac{2 π}{{λ}_{0}} ψ ( r ) \\ ψ ( r ) = {a}_{1} r + {a}_{2} {r}^{2} + {a}_{3} {r}^{3} + {a}_{4} {r}^{4} + {a}_{5} {r}^{5} + {a}_{6} {r}^{6} + … + {a}_{i} {r}^{i} \\ ( {r}^{2} = {x}^{2} + {y}^{2} ) \qquad ( 1 )$$

where φ is a phase function, ψ is an optical path length difference function, r is a radial distance from the optical axis, λ₀ is a designed wavelength, and a₁, a₂, a₃, a₄, a₅, a₆, . . . and aᵢ are coefficients.

As can be seen from FIG. 30(b), in the diffraction grating that uses first-order diffracted light, a diffraction ring zone is arranged every time the phase increases by 2π in the phase function φ(r). The shape of the diffraction grating surface shown in FIG. 30(c) is determined by adding the phase shape that is divided every 2π to the aspheric shape shown in FIG. 30(a). Specifically, the value of the phase function shown in FIG. 30(b) is changed so that the step height 241 of each zone to be the diffraction ring zone satisfies the following Equation (2) and then added to the aspheric shape shown in FIG. 30(a):

$$d = \frac{{m}_{o} \cdot λ}{{n}_{1} ( λ ) - 1} \qquad ( 2 )$$

where mₒ is a designed order (e.g., mₒ==1 as for first-order diffracted light), λ is the designed wavelength, d is the step height of the diffraction grating, and n₁(λ) is the refractive index of the lens body at the designed wavelength λ and is a function of the wavelength. In a diffraction grating that satisfies this Equation (2), the phase difference between the root and the end of a diffraction step portion becomes 2 π. Consequently, the diffraction efficiency of first-order diffracted light (which will be referred to herein as “first-order diffraction efficiency”) with respect to light with a single wavelength can be approximately equal to 100%.

As the wavelength λ varies, the d value at which the diffraction efficiency becomes 100% also varies in accordance with Equation (2). Conversely, if the d value is fixed, the diffraction efficiency can be 100% at no other wavelength but at the wavelength λ that satisfies Equation (2). If a diffraction grating lens is used for general image capturing purposes, light falling within a broad wavelength range (e.g., a visible radiation wavelength range of approximately 400 nm to 700 nm) needs to be diffracted. For that reason, not only a first-order diffracted light ray 255 as a main light ray but also other diffracted light rays 256 of unnecessary orders (which will be sometimes referred to herein as “unnecessary order diffracted light rays”) are produced as shown in FIG. 31. For example, if the wavelength that determines the step height d is supposed to be a green ray wavelength (e.g., 540 nm), then the first-order diffraction efficiency becomes 100% and no unnecessary order diffracted light rays 256 are produced at the green ray wavelength. At a red ray wavelength (e.g., 640 nm) or at a blue ray wavelength (e.g., 440 nm), however, the first-order diffraction efficiency does not become 100% and a zero-order diffracted red ray or a second-order diffracted blue ray will be produced as an unnecessary order diffracted light ray 256, which deteriorates the image quality with flares or ghosts or degrades the MTF (modulation transfer function) characteristic. In FIG. 31, only a second-order diffracted light ray is illustrated as the unnecessary order diffracted light ray 256.

If the surface with the diffraction grating 252 is coated or joined with an optical adjustment film 261 of an optical material that has a different refractive index and a different refractive index dispersion from the lens body 251 as shown in FIG. 32, generation of the unnecessary order diffracted light ray 256 can be minimized. Patent Document No. 1 discloses an example in which the wavelength dependence of the diffraction efficiency is reduced by setting the refractive index of the base member with the diffraction grating 252 and that of the optical adjustment film 261 that covers the diffraction grating 252 to satisfy a particular condition. As a result, the flares involved with the unnecessary order diffracted light rays 256 can be eliminated as shown in FIG. 31.

Meanwhile, Patent Document No. 2 discloses that in order to prevent a light ray that has been reflected from the stepped surface 262 of the diffraction grating 252 from being transmitted through the blazed surface and being flare light, a light absorbing portion is arranged around the root of the sloping surface of the diffraction ring zone and the light reflected from the stepped surface is cut by the light absorbing portion.

### CITATION LIST

### Patent Literature

Patent Document No. 1: Japanese Laid-Open Patent Publication No. 09-127321
Patent Document No. 2: Japanese Laid-Open Patent Publication No. 2006-162822

### SUMMARY OF INVENTION

### Technical Problem

The present inventors discovered that as the diffraction ring zone pitch of the diffraction grating of a diffraction grating lens was reduced or when a subject with an extremely high light intensity was captured, fringed flare rays, having a different pattern from the unnecessary order diffracted light rays 256 described above, would be produced. Nobody else should know that such fringed flare rays will be produced in a diffraction grating lens. The present inventors also discovered that such fringed flare rays could debase the quality of an image shot significantly under certain conditions.

In order to overcome these problems, the present invention has been made to provide a diffraction grating lens that can minimize generation of such fringed flare rays and also provide an imaging optical system and image capture device that use such a lens.

### Solution to Problem

An imaging optical system according to the present invention includes: at least one diffraction grating lens with a diffraction grating that is made up of q diffraction ring zones; and a stop. A surface of the at least one diffraction grating lens that has the diffraction grating is a lens surface that is located closest to the stop. Supposing the respective widths of diffraction ring zones that are located first, second, (m−1)^{th} and m^{th} closest to the optical axis of the optical system are identified by P₁, P₂, Pₘ₋₁ and Pₘ, at least one m that falls within the range 3<m≦q satisfies the following Inequality (3):

$$k = \frac{( \frac{1}{{P}_{m - 1}} \cdot \frac{{P}_{m - 1} - {P}_{m}}{{P}_{m - 1} \cdot {P}_{m}} )}{( \frac{1}{{P}_{1}} \cdot \frac{{P}_{1} - {P}_{2}}{{P}_{1} \cdot {P}_{2}} )} > 1.6 \qquad ( 3 )$$

An image capture device according to the present invention includes: an imaging optical system according to the present invention; an image sensor; and an image processor.

### Advantageous Effects of Invention

According to the present invention, by making fringed flare rays, which have been produced by respective diffraction ring zones, interfere with each other, the variation in the intensity of the fringes can be reduced. As a result, even when an intense light source needs to be captured, an image with just a few fringed flare rays can also be obtained.

### BRIEF DESCRIPTION OF DRAWINGS

FIG. 1 A cross-sectional view schematically illustrating a first embodiment of a diffraction grating lens according to the present invention.

FIG. 2 An enlarged view of the diffraction grating lens of the first embodiment.

FIG. 3 (a) is a graph showing the phase function φc of a diffraction grating lens (as a comparative example) that was designed to just obtain an ordinary characteristic without trying to reduce fringed flare light, and (b) and (c) are graphs respectively showing the first-order and second-order derivatives φc′ and φc″ of the phase function φc of the comparative example.

FIG. 4 (a) is a graph showing the phase function φe of a diffraction grating lens according to the first embodiment that was specially designed to reduce fringed flare light, and (b) and (a) are graphs respectively showing the first-order and second-order derivatives φe′ and φe″ of the phase function φe of the first embodiment.

FIG. 5 (a) through (d) are graphs showing how to calculate the degree of clearness of fringes.

FIG. 6 A graph showing how the degree of clearness of the fringes changes with the k value of the conditional formula.

FIG. 7 A flowchart showing how to design a diffraction grating lens according to the first embodiment.

FIGS. 8 (a) and (b) show how the fringe interval of fringed flare light 281 changes with the width of a diffraction ring zone 271.

FIG. 9 A flowchart showing specifically how to design the diffraction grating lens of the first embodiment.

FIG. 10 A cross-sectional view schematically illustrating a second embodiment of a diffraction grating lens according to the present invention.

FIG. 11 An enlarged view of a portion of the diffraction grating lens of the present invention.

FIGS. 12 (a) and (b) are respectively a schematic cross-sectional view and a plan view illustrating an embodiment of an optical element according to the present invention and (a) and (d) are respectively a schematic cross-sectional view and a plan view illustrating a modified example of the optical element of the third embodiment.

FIG. 13 A graph showing the cross-sectional intensity distribution of fringed flare light in a diffraction grating lens representing a first example.

FIG. 14 A graph showing the cross-sectional intensity distribution of fringed flare light in a diffraction grating lens representing a second example.

FIG. 15 A graph showing the cross-sectional intensity distribution of fringed flare light in a diffraction grating lens representing a third example.

FIG. 16 A graph showing the cross-sectional intensity distribution of fringed flare light in a diffraction grating lens representing a comparative example.

FIG. 17 A cross-sectional view illustrating an imaging optical system representing a fourth example.

FIG. 18 Shows the aberrations involved with the imaging optical system of the fourth example.

FIG. 19 Shows the distribution of intensities of a spot that was formed by the imaging optical system of the fourth example.

FIG. 20 A cross-sectional view illustrating an imaging optical system representing a fifth example.

FIG. 21 Shows the aberrations involved with the imaging optical system of the fifth example.

FIG. 22 Shows the distribution of intensities of a spot that was formed by the imaging optical system of the fifth example.

FIG. 23 A cross-sectional view illustrating an imaging optical system representing a sixth example.

FIG. 24 Shows the aberrations involved with the imaging optical system of the sixth example.

FIG. 25 Shows the distribution of intensities of a spot that was formed by the imaging optical system of the sixth example.

FIG. 26 A cross-sectional view illustrating an imaging optical system representing a second comparative example.

FIG. 27 Shows the aberrations involved with the imaging optical system of the second comparative example.

FIG. 28 Shows the distribution of intensities of a spot that was formed by the imaging optical system of the second comparative example.

FIG. 29 A cross-sectional view schematically illustrating an embodiment of an image capture device according to the present invention.

FIG. 30 (a) through (c) illustrate how to determine the diffraction grating surface shape of a diffraction grating lens.

FIG. 31 Illustrates how unnecessary diffracted light rays are produced in a diffraction grating lens.

FIG. 32 A cross-sectional view illustrating a diffraction grating lens with an optical adjustment film.

FIG. 33 Illustrates a ring zone of a diffraction grating lens as viewed in the optical axis direction.

FIG. 34 Illustrates how fringed flare light is produced by a diffraction grating lens.

FIG. 35 Illustrates how fringed flare light is produced by a diffraction grating lens.

FIGS. 36 (a) and (b) show an exemplary image that was shot with an image capture device including a known diffraction grating lens.

### DESCRIPTION OF EMBODIMENTS

First of all, the fringed flare ray to be produced by a diffraction grating lens, which was discovered by present inventors, will be described.

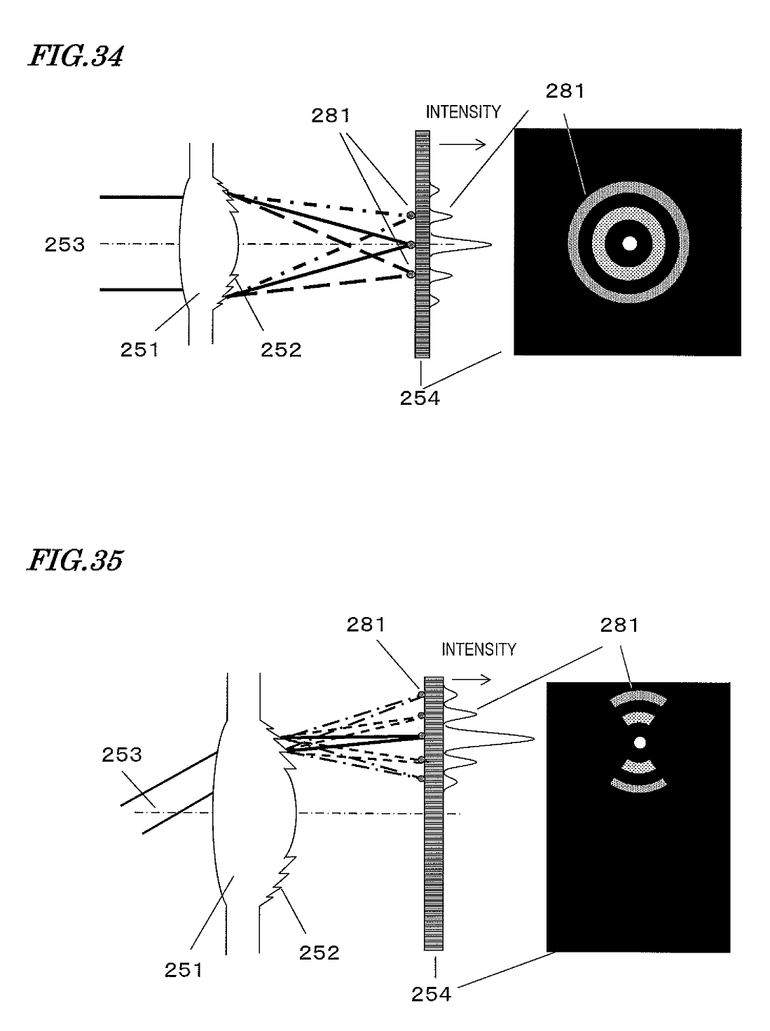

As shown in FIG. 33, in a diffraction grating lens with a diffraction grating 252, each of the diffraction ring zones 271 is interposed between associated two of the stepped surfaces that are arranged concentrically. That is why the wavefront of a light ray that is transmitted through two adjacent diffraction ring zones 271 is split into two by the stepped surface between the two diffraction ring zones 271. The light ray being transmitted through each diffraction ring zone 271 can be regarded as a light ray passing through a slit, of which the width is defined by the pitch P of the diffraction ring zone 271. Generally speaking, if the pitch P of the diffraction ring zones 271 is reduced, the aberration can be corrected well. However, if the pitch of the diffraction ring zones 271 decreases, the light being transmitted through the diffraction grating lens can be regarded as light passing through very narrow slits that are arranged concentrically. As a result, in the vicinity of the stepped surfaces, a bypassing phenomenon of the wavefront of the light is observed. FIG. 34 schematically illustrates how incoming light enters a lens body 251 with the diffraction grating 252 and how its outgoing light gets diffracted by the diffraction grating 252.

Generally speaking, a light ray that has passed through a slit with a very narrow pitch P will form diffraction fringes at a viewpoint at infinity, which is so-called “Fraunhofer diffraction”. If a lens system with a positive focal length is included, such a diffraction phenomenon also arises at a finite distance (i.e., on a focal plane).

The present inventors confirmed, by evaluating an image using a real lens, that as the pitch of the diffraction ring zones 271 decreased, the light rays transmitted through the respective ring zones would more and more interfere with each other to produce fringed flare 281 with a concentric pattern as shown in FIG. 34. We also confirmed, by evaluating an image using a real lens, that light being incident obliquely to the optical axis and passing through only a part of the diffraction ring zones could produce fringed flare light 281 as shown in FIG. 35, which looks like a butterfly with unfolded wings.

The present inventors also discovered as a result of extensive researches that such fringed flare light will be produced significantly if light with an even higher intensity than the incoming light to produce the well-known unnecessary order diffracted light 256 is incident on the imaging optical system and that the unnecessary order diffracted light 256 is not produced at particular wavelengths but the fringed flare light 281 is produced in the entire operating wavelength range including the designed wavelength.

Such fringed flare light 281 spreads more broadly on the image than the unnecessary order diffracted light 256, thus debasing the image quality. Particularly in an unusual shooting environment with an extremely high contrast ratio (e.g., when a bright subject such as a light needs to be shot on a totally dark background at night, for example), the fringed flare light 281 would get even more noticeable and cause a problem. On top of that, the fringed flare light 281 has a clear-cut fringed bright and dark pattern, and therefore, is much more noticeable on the image than the unnecessary order diffracted light 256, which is a serious problem.

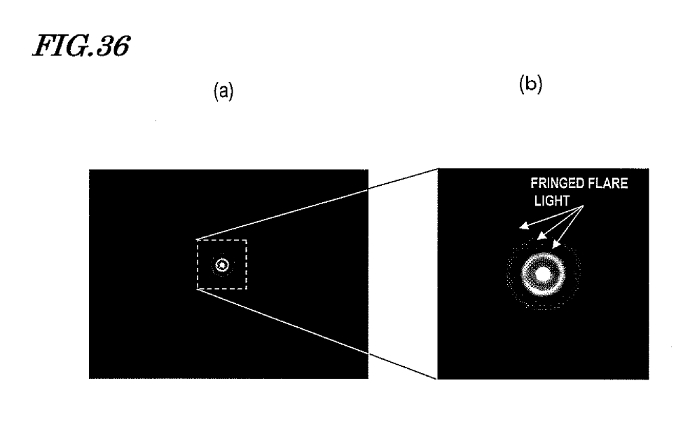

FIG. 36(a) shows an exemplary image that was shot with an image capture device including a known diffraction grating lens. Specifically, the image shown in FIG. 36(a) was obtained by capturing a point light source with the indoor light turned off, and FIG. 36(b) is an enlarged view of a part of the image shown in FIG. 36(a) including the point light source and its surrounding region. In FIG. 36(b), the bright and dark ring image that can be seen around the point light source is the fringed flare light 281.

Hereinafter, specific embodiments of the present invention will be described with reference to the accompanying drawings.

### Embodiment 1

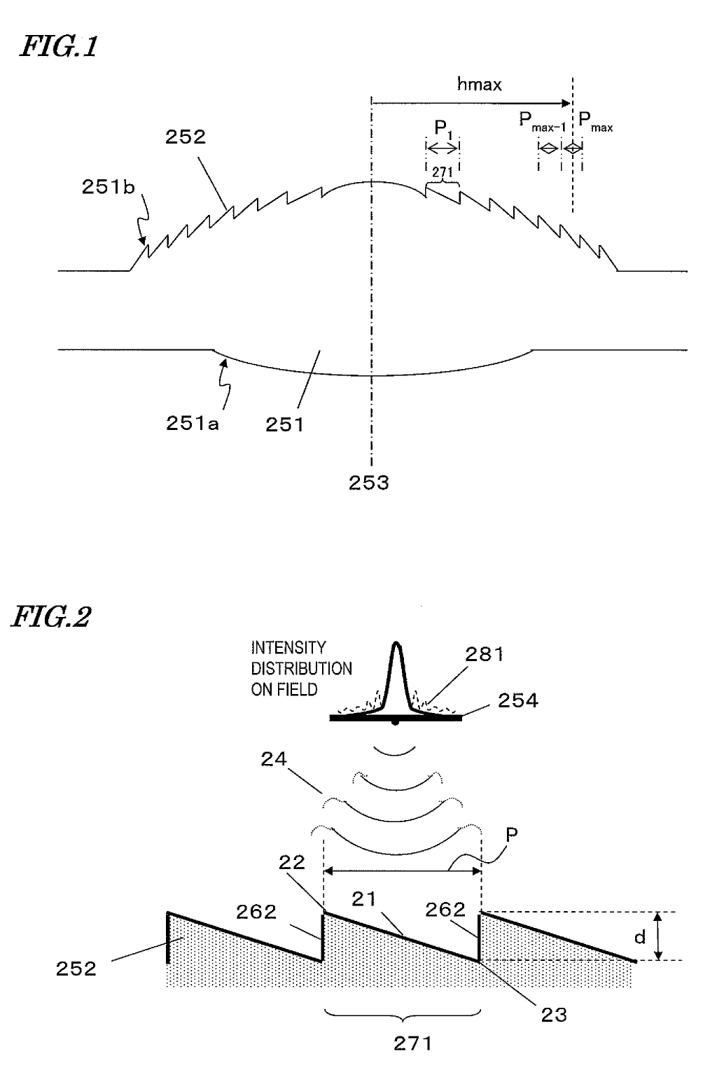

FIG. 1 is a cross-sectional view schematically illustrating a first embodiment of a diffraction grating lens according to the present invention. The diffraction grating lens 1 shown in FIG. 1 includes a lens body 251 and a diffraction grating 252 that has been formed on the surface of the lens body 251. The lens body 251 has first and second surfaces 251a and 251b and the second surface 251b has the diffraction grating 252.

Although the diffraction grating 252 is arranged on the second surface 251b in this embodiment, the diffraction grating 252 may also be arranged on the first surface 251a. Also, even though an embodiment in which the stepped surfaces 262 face inward is illustrated in FIG. 1, the stepped surfaces 262 may face the opposite direction (i.e., outward).

Also, even though the basic shape of the first and second surfaces 251a and 251b is an aspheric shape according to this embodiment, the basic shape may also be a spherical shape or a plate shape. The first and second surfaces 251a and 251b may have either the same basic shape or mutually different basic shapes. Furthermore, the basic shape of the first and second surfaces 251a and 251b is a convex aspheric shape, but may also be a concave aspheric shape. Optionally, one of the first and second surfaces 251a and 251b may have a convex basic shape and the other a concave basic shape.

FIG. 2 is an enlarged view of the diffraction grating lens of this embodiment. The diffraction grating 252 includes a plurality of diffraction ring zones 271 and a plurality of stepped surfaces 262. One stepped surface 262 is provided between two adjacent diffraction ring zones 271. Each diffraction ring zone 271 has a sloping surface 21 that slopes in the width direction of that ring zone. Also, each stepped surface 262 is connected to the edge 22 of one of the two adjacent sloping surfaces 21 and to the root 23 of the other adjacent sloping surface 21. That is to say, the diffraction ring zone 271 is a ringlike zone interposed between two stepped surfaces 262.

In this embodiment, the “width (or pitch) P of a diffraction ring zone 271” refers herein to the shortest distance between two stepped surfaces 262 that interpose that diffraction ring zone 271 between them. In this case, the shortest distance between the two stepped surfaces 262 is usually the length as measured on a plane that intersects with the optical axis at right angles, not the length as measured along the sloping surface 21 of the diffraction ring zone 271. As shown in FIG. 1, the width of the first diffraction ring zone 271 as counted from the one that is located closest to the optical axis is represented by P₁, the width of the diffraction ring zone 271 that is located one zone closer to the optical axis than the position of the effective diameter hₘₐₓ is represented by Pₘₐₓ₋₁, and the width of the diffraction ring zone 271 that is located at the position of the effective diameter hₘₐₓ is represented by Pₘₐₓ.

In this embodiment, the diffraction ring zones 271 are arranged concentrically with respect to the optical axis 253 of the aspheric basic shape (see FIG. 1) of the second surface 251b. The diffraction ring zones 271 do not always have to be arranged concentrically. Nonetheless, in order to improve the aberration property of an optical system for use to capture an image, it is still recommended that the diffraction ring zones 271 be rotationally symmetric with respect to the optical axis 253. The wavefront that has been split into two by a stepped surface 262 passes through a sloping surface 21 and then brings about a wavefront bypassing phenomenon 24, which is a factor causing the fringed flare light 281.

Also, the height d of the stepped surface 262 satisfies the following Equation (2):

$$d = \frac{{m}_{o} \cdot λ}{{n}_{1} ( λ ) - 1} \qquad ( 2 )$$

where mₒ is the order of design (e.g., mₒ=1 in the case of the first-order diffracted light), λ is the designed wavelength, and n₁(λ) is the refractive index of the material for the lens body at λ.

In this embodiment, the diffraction grating 252 has diffraction ring zones that satisfy the following Inequality (3):

$$k = \frac{( \frac{1}{{P}_{m - 1}} \cdot \frac{{P}_{m - 1} - {P}_{m}}{{P}_{m - 1} \cdot {P}_{m}} )}{( \frac{1}{{P}_{1}} \cdot \frac{{P}_{1} - {P}_{2}}{{P}_{1} \cdot {P}_{2}} )} > 1.6 \qquad ( 3 )$$

In Inequality (3), P₁ and P₂ denote the respective widths of the first and second diffraction ring zones as counted from the one that is located closest to the optical axis and Pₘ and Pₘ₋₁ denote the respective widths of the m^{th} and (m−1)^{th} diffraction ring zones as counted from the one that is located closest to the center of the diffraction plane.

The middle of Inequality (3) represents the ratio of the variation in the gradient (the second-order differentiated value) of the phase function of a diffraction ring zone relatively close to the center (i.e., the first or second ring zone as counted from the one that is located closest to the optical axis) and that of another diffraction ring zone relatively distant from the center (i.e., the (m−1)th or m^{th} ring zone as counted from the one that is located closest to the optical axis). The greater that ratio of the variation in the gradient of the phase function of the (m−1)^{th} or m^{th} diffraction ring zone as counted from the one that is located closest to the optical axis to that of the first or second diffraction ring zone as counted from the one that is located closest to the optical axis, the larger the value of the middle of Inequality (3).

In the diffraction grating 252 of this embodiment, there is a diffraction ring zone in which the middle of Inequality (3) has a value that is greater than 1.6. In a known diffraction grating lens, on the other hand, there are no such diffraction ring zones that could satisfy such a condition. This means that according to this embodiment, the variation in the gradient of the phase function in the (m−1)th or m^{th} diffraction ring zone as counted from the one that is located closest to the optical axis is greater than in the known lens. In other words, even though the diffraction ring zones that are relatively distant from the center have non-uniform widths according to this embodiment, such diffraction ring zones that are relatively distant from the center have a constant width in the known lens. This respect will be described in detail later.

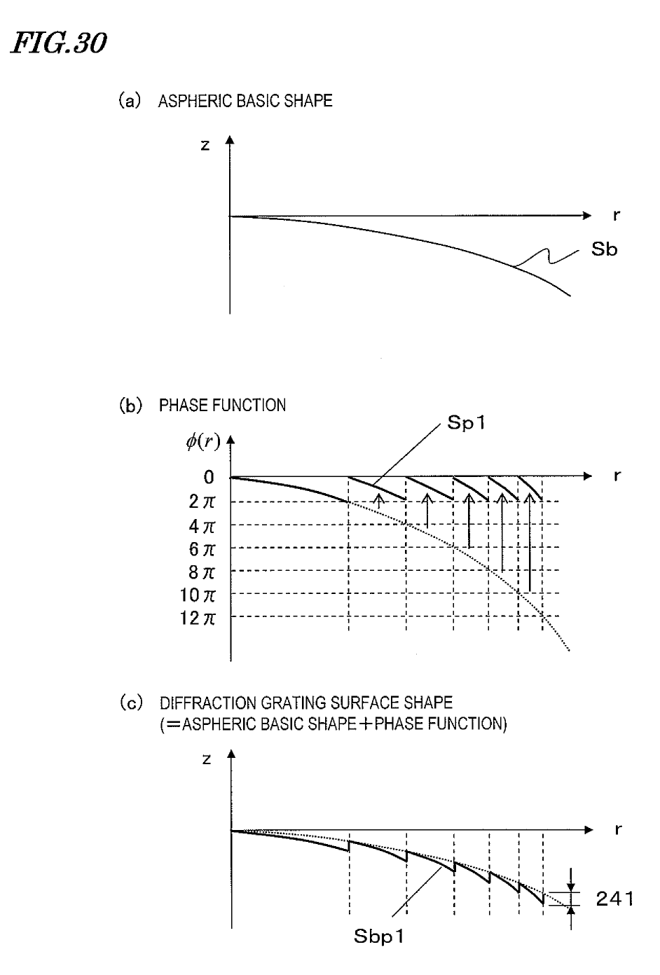

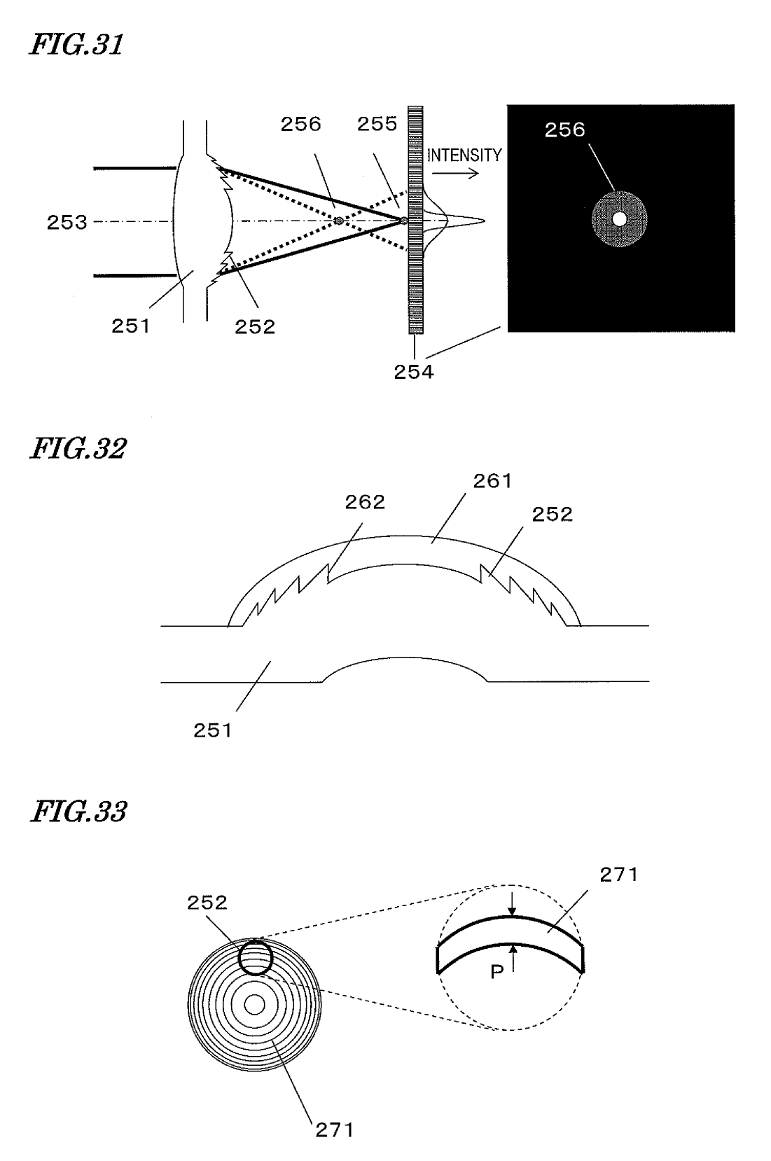

As already described with reference to FIG. 30, the greater the gradient of the phase function, the shorter the width of the diffraction ring zone. In general, the width of a diffraction ring zone is set to be equal to or greater than a certain value. The present inventors discovered, as a result of an extensive research, that in a known diffraction grating lens, the widths of diffraction ring zones that are relatively distant from the center cannot be gradually decreased as the distance from the center increases but actually are constant. The interval between the diffraction fringes to be produced when light passes through each diffraction ring zone heavily depends on the width of the ring zones. And the diffraction fringes to be produced by the light passing through two diffraction ring zones with the same ring zone width have substantially the same fringe interval. That is why if light passes through areas with the constant diffraction ring zone width, then diffraction fringes with substantially the same fringe interval are produced and interfere with each other so as to intensify each other. As a result, easily sensible fringed flare light is produced. According to this embodiment, the width of such diffraction ring zones that are relatively distant from the center can be decreased gradually as the distance from the center increases. Consequently, according to this embodiment, such diffraction ring zones that are relatively distant from the center can have non-uniform widths, and therefore, generation of fringed flare light can be reduced significantly.

As a comparative example, the present inventors designed a diffraction grating lens that would just exhibit an ordinary characteristic without trying to reduce the fringed flare light. In the following description, Inequality (3) will be analyzed in further detail with the results of simulations that had been carried out on the diffraction grating lenses of the comparative example and this embodiment compared to each other.

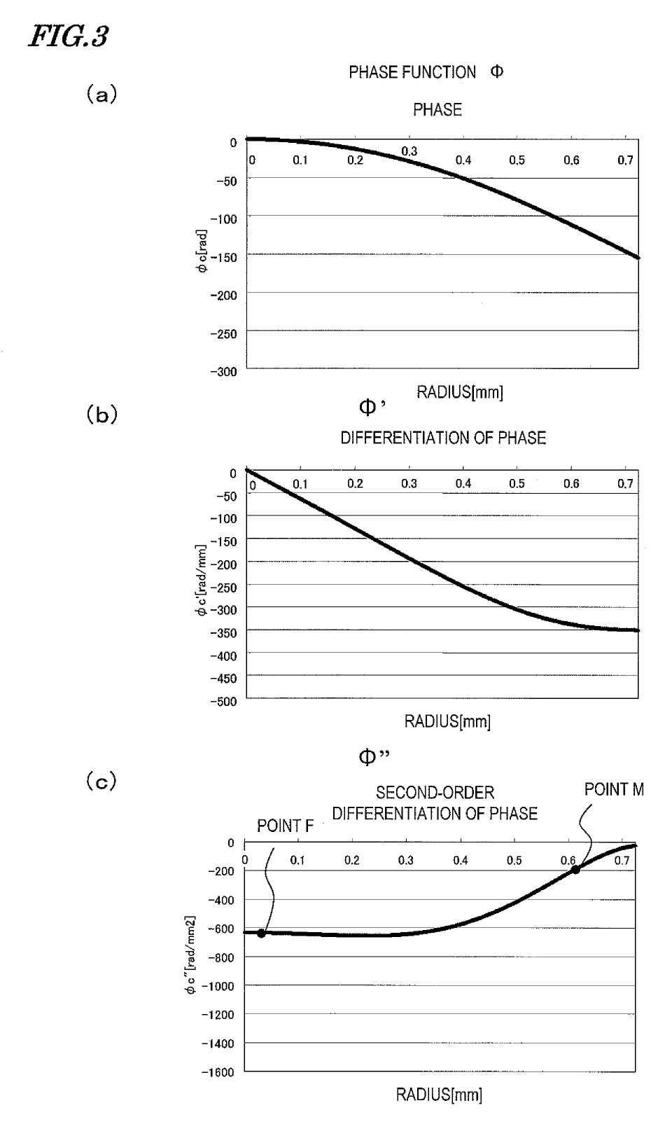

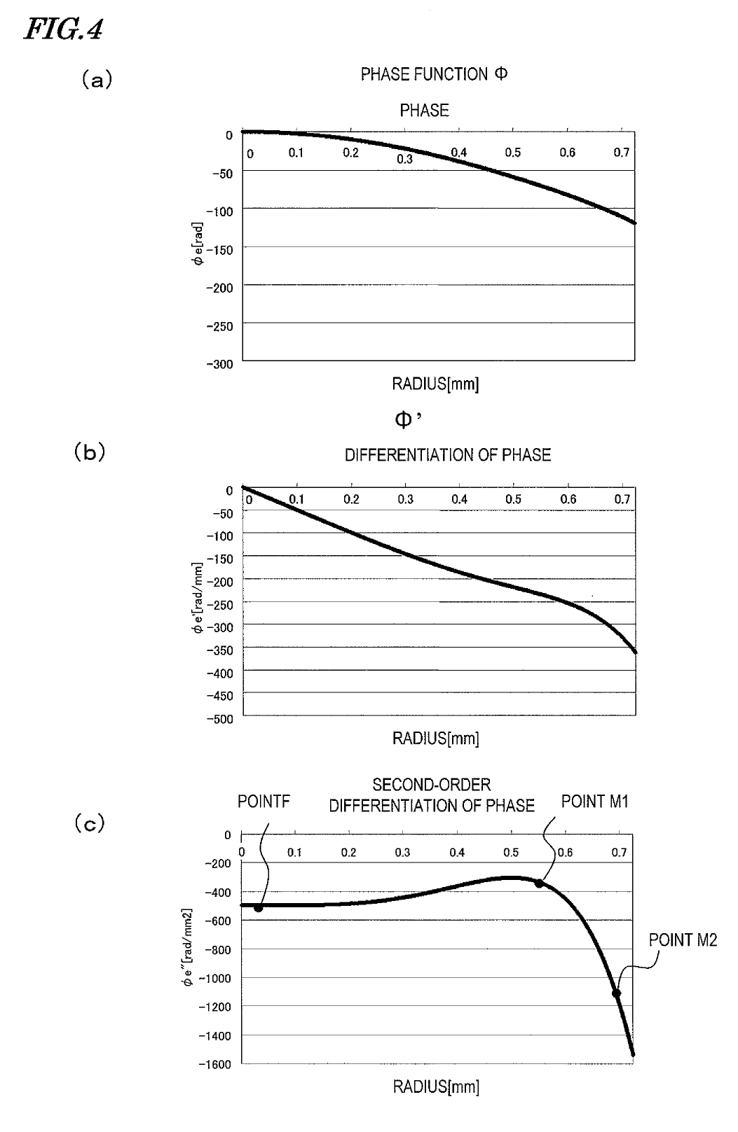

FIG. 3(a) is a graph showing the phase function φc of such a diffraction grating lens (as a comparative example) that was designed to just obtain an ordinary characteristic without trying to reduce the fringed flare light. On the other hand, FIG. 4(a) is a graph showing the phase function φe of a diffraction grating lens according to this embodiment that was specially designed to reduce the fringed flare light. In the graphs shown in FIGS. 3(a) and 4(a), the ordinate represents the phase difference (rad) and the abscissa represents the distance as measured from the center of the lens (i.e., the radius of the diffraction grating).

Comparing FIGS. 3(a) and 4(a) to each other, it can be seen that in the abscissa range of 0 through about 0.6, the (absolute value of the) gradient of the phase function is greater in FIG. 3(a) than in FIG. 4(a). However, once the abscissa exceeds about 0.6, the gradient of the phase function becomes nearly constant in FIG. 3(a) but rather increases in FIG. 4(a).

FIGS. 3(b) and 3(c) are graphs respectively showing the first-order and second-order derivatives φc′ and φc″ of the phase function φc of the comparative example. As can be seen from FIG. 3(b), if the abscissa falls within the range of to about 0.6, the larger the abscissa, the greater the (absolute value of the) gradient of the phase function φc in the comparative example. But once the abscissa exceeds around 0.6, the gradient of the phase function φc becomes nearly constant. Thus, it can be seen easily from the result shown in this graph that the phase function φc shown in FIG. 3(a) becomes a nearly linear one when the abscissa exceeds around 0.6.

Normally, when a diffraction grating lens is designed, the width of the diffraction ring zones is set to be at least equal to some value in order to avoid decreasing the transmittance too much due to the loss of light rays at the diffraction stepped portions and to form the intended diffraction grating shape relatively easily. Also, as already described with reference to FIG. 30(b), the diffraction, ring zones are arranged one after another every time the phase of the phase function increases by 2 π. That is why the steeper the gradient of the phase function, the shorter the width of the diffraction ring zones gets. Even in the comparative example, the width of the diffraction ring zones needs to be set to be at least equal to some value. For that reason, in a diffraction ring zone that is relatively distant from the center, the increase in the gradient of the phase function would be checked, and therefore, the phase function φc would become a nearly linear one.

The rate of change (i.e., the differential coefficient) of the values shown in the graph of FIG. 3(b) is shown in FIG. 3(c). Since the ordinate (i.e., the gradient of the phase function φc) in the graph shown in FIG. 3(b) becomes a nearly constant one once the abscissa exceeds around 0.6, the ordinate in the graph shown in FIG. 3(c) goes closer to zero.

FIGS. 4(b) and 4(c) are graphs respectively showing the first-order and second-order derivatives φe′ and φ″ of the phase function φe of this embodiment. As can be seen from FIG. 4(b), if the abscissa is equal to zero, the ordinate (representing the gradient of the phase function φe of this embodiment) is also equal to zero. But if the abscissa falls within the range of 0 to 0.6, the ordinate decreases gently. And the rate of decrease in ordinate starts to increase once the abscissa exceeds around 0.6. Thus, it can be seen that the absolute value of the phase function φe of this embodiment shown in FIG. 4(a) starts to increase when the abscissa exceeds around 0.6.

Since the ordinate (representing the gradient of the phase function φe) in the graph shown in FIG. 4(b) starts to decrease significantly when the abscissa exceeds around 0.6, the ordinate (representing the rate of change of the graph shown in FIG. 4(b)) in the graph shown in FIG. 4(c) also starts to be significantly different from zero.

Next, it will be described how to derive the middle of Inequality (3).

Suppose the diffraction grating lens of this embodiment has q diffraction ring zones 271 that satisfy the equation of phase function. If the width of the x^{th} diffraction ring zone 271 as counted from the one that is located closest to the center of the diffraction grating lens is identified by Pₓ, the gradients (i.e., the values shown in FIG. 4(b)) φe″ of the phase function of the first, second, . . . and m^{th} diffraction ring zones 271 as counted from the one that is located closest to the center of the diffraction grating lens can be approximated to be φe(1) =2 π/P₁, φe(2)′=2 π/P₂, . . . and φe(m)′=2 π/Pₘ, respectively, where m is an integer that is equal to or greater than three.

On the other hand, the rate of change (i.e., the value shown in FIG. 4(c)) φe″ of the gradient of the phase function φe is calculated by the following Equations (5), (6) and (7):

$$\begin{matrix}{{φ}_{e} ( 1 )}^{″} \approx \frac{{{φ}_{e} ( 2 )}^{′} - {{φ}_{e} ( 1 )}^{′}}{{P}_{1}} = d ( \frac{1}{{P}_{1}} \times \frac{{P}_{1} - {P}_{2}}{{P}_{1} \cdot {P}_{2}} ) & ( 5 ) \\ {{φ}_{e} ( 2 )}^{″} \approx \frac{{{φ}_{e} ( 3 )}^{′} - {{φ}_{e} ( 2 )}^{′}}{{P}_{2}} = d ( \frac{1}{{P}_{2}} \times \frac{{P}_{2} - {P}_{3}}{{P}_{2} \cdot {P}_{3}} ) & ( 6 ) \\ {{φ}_{e} ( m )}^{″} \approx \frac{{{φ}_{e} ( m + 1 )}^{′} - {{φ}_{e} ( m )}^{′}}{{P}_{m}} = d ( \frac{1}{{P}_{m}} \times \frac{{P}_{m} - {P}_{m + 1}}{{P}_{m} \cdot {P}_{m + 1}} ) & ( 7 )\end{matrix}$$

k is defined by the following Equation (8):

k=Φₑ(m)″/Φₑ(1)″ (8)

where 3<m≦q

By substituting the values of Equations (5) and (7) into Equation (8), the middle of Inequality (3) can be obtained.

Equations (5), (6) and (7) represent values on the graph shown in FIG. 4(c). As a value corresponding to φe(1)″ in Equation (8), a point F is plotted on the graph shown in FIG. 4(c). Since m is a value falling within the range 3<m≦q in Equation (8), a point corresponding to φe(m)″ can be plotted anywhere on the graph shown in FIG. 4(c) (except φe(1)″ and φe(2)″, though). In this example, points M1 and M2 are plotted on the graph shown in FIG. 4(c) as exemplary values corresponding to φe(m)″. The points F, M1 and M2 are about −500, about −360 and about −1100, respectively. If the value at the point M1 is substituted into Equation (8), then the k value becomes 0.7. On the other hand, if the value at the point M2 is substituted into Equation (8), then the k value becomes 2.2. These results reveal that according to this embodiment, by selecting such an m value for φe(m)″, the k value can be greater than 1.6.

Equation (8) represents the relation of the second-order derivative φe″ according to this embodiment. Meanwhile, the relation of the second-order derivative φc″ according to the comparative example is represented by the following Equation (9):

k_{c}=Φ_{c}(m)″Φ_{c}(1)″ (9)

As a value corresponding to φc(1)″ in Equation (9), a point F is plotted on the graph shown in FIG. 3(c). A point M is plotted on the graph shown in FIG. 3(c) as an exemplary value corresponding to φc(m)″. The points F and M are about −630 and about −200, respectively. If these values are substituted into Equation (9), then the kc value becomes 0.3. The point M can be plotted anywhere on the graph shown in FIG. 3(c) (except φc(1)″ and φc(2)″, though). Since the minimum value is approximately −650 in the graph shown in FIG. 3(c), the maximum value of kc is approximately 1, no matter where the point M is plotted.

As described above, the k value of this embodiment can be greater than kc of the comparative example.

It should be noted that FIGS. 3(a) through 3(c) and FIGS. 4(a) through 4(c) show the phase functions of the first diffraction ring zone that is located closest to the optical axis through the diffraction ring zone that is located more distant from the optical axis than any other diffraction ring zone that satisfies the phase function equation. If the diffraction grating lens of this embodiment is used in an imaging optical system, the effective diameter (hₘₐₓ) is determined by the stop and the angle of view. The diffraction ring zones that satisfy the phase function equation may either cover a lens surface range from the optical axis through the effective diameter position or extend beyond the effective diameter position. Also, the diffraction grating provided may be unable to satisfy the phase function equation outside of the effective diameter range.

Next, it will be described how to derive the threshold value (i.e., the value on the right side) of Inequality (3).

As shown in FIG. 34, the fringed flare light 281 produced from the diffraction ring zones 271 is fringed flare, of which the intensity alternately changes steeply to form a bright and dark pattern. The fringe interval of the fringed flare light 281 produced from a diffraction ring zone 271 is inversely proportional to the width of that diffraction ring zone 271. That is to say, the greater the width of the diffraction ring zone 271, the narrower the fringe interval of the fringed flare light 281. On the other hand, the smaller the width of the diffraction ring zone 271, the wider the fringe interval of the fringed flare light 281. The image produced on the field by a diffraction grating lens with multiple diffraction ring zones 271 becomes a superposition of the fringed flare light rays 281 produced by those diffraction ring zones 271. That is why by controlling the widths of the diffraction ring zones, the flare light rays 281 produced from those diffraction ring zones 271 can interfere with each other and the variation in the intensity (i.e., bright and dark contrast) of the fringed flare light 281 can be reduced.

First of all, in order to obtain the threshold value of Inequality (3), the degree of clearness of the fringes of the fringed flare light 281 produced is defined. Portion (a) of FIG. 5 shows the distribution of intensities at a cross section of a spot that has been imaged on the image capturing plane through a diffraction grating lens. If there is the fringed flare light 281, then a wavy intensity distribution such as the one shown in portion (a) of FIG. 5 is obtained. Portion (b) of FIG. 5 shows a differentiated one of such an intensity distribution. A range with a positive fringe gradient in portion (a) of FIG. 5 comes to have a positive value in FIG. 5(b). In this case, the greater the magnitude of the waviness shown in portion (a) of FIG. 5 (i.e., the greater the degree of clearness of the bright and dark fringes), the more significantly the differentiated values of the fringe intensities change in portion (b) of FIG. 5. Conversely, if the fringes have no waviness at all as shown in portion (c) of FIG. 5, then the differentiated values of the fringe intensities will no longer have positive values as shown in portion (d) of FIG. 5. That is why the accumulation of the positive differentiated values of the fringe intensities had better be defined to be the degree of clearness of the fringes. In that case, it means that the smaller the degree of clearness of the fringes, the smaller the waviness of the fringe intensities. Specifically, the accumulated value of the shadowed areas shown in portion (b) of FIG. 5 represents the degree of clearness of the fringes. In this case, as for negative differentiated values, the greater their absolute values, the greater the magnitudes of waviness of the fringes. That is why it seems that the negative values, as well as the positive values, had better be accumulated. However, the skirt surrounding the center of the spot also has a negative value, and it would be impossible to tell the skirt from the other wavy ranges. For that reason, only those positive values had better be accumulated together to obtain the degree of clearness of the fringes. When the degree of clearness of the fringes was calculated, the accuracy of calculation was increased by being multiplied by the moving average before and after the differentiation in order to reduce the error due to high-frequency components.

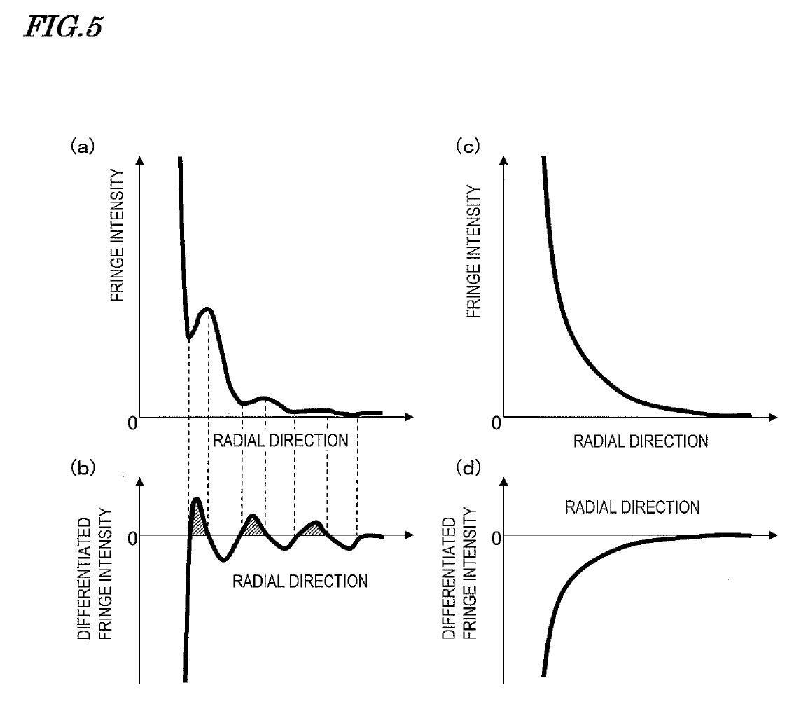

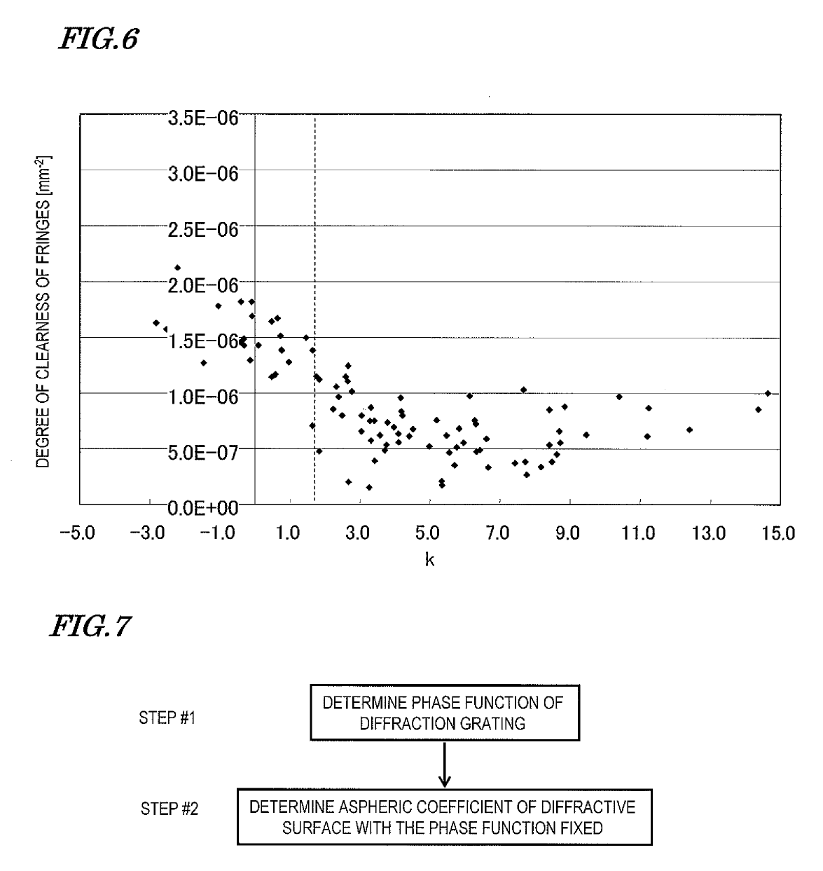

FIG. 6 plots the degrees of clearness of the fringes that were obtained based on the data of a diffraction grating lens with various diffraction ring zone widths. In FIG. 6, the abscissa represents the left side k of Inequality (3) and the ordinate represents the degree of clearness of the fringes of the fringed flare light 281. Specifically, the respective coefficients of the phase function (represented by Equation (1)) were varied as parameters at regular intervals. If the respective coefficients of the phase function are varied, then the width of the diffraction ring zones to be formed also changes. Also, if the respective coefficients are varied over a broad range, combinations of the widths of the diffraction ring zone can also be confirmed over a broad range. In this case, the smaller the degree of clearness of fringes, the less significantly the bright and dark contrast of the fringes varies and the better. As can be seen from FIG. 6, if the k value is set to be 1.6 or more, the degree of clearness of the fringes can be reduced with stability. Furthermore, the present inventors confirmed by an analytic method that if the degree of clearness of the fringes was 10⁻⁶ (i.e., 10e−6) mm⁻² or less, the fringed flare light 281 was unnoticeable and a good image could be obtained when a light source, of which the luminance was approximately as high as that of an indoor fluorescent lamp, was shot. By setting the k value to be 1.6 or less, the degree of clearness of the fringes can be reduced to approximately 10⁻⁶ mm⁻² or less.

If the height of the diffraction steps is represented by d, the width P of the diffraction ring zones 271 may be defined so that every diffraction ring zone 271 satisfies the following Inequality (10) within the effective diameter:

P>d (10)

Unless Inequality (10) is satisfied, the width of the diffraction ring zones 271 becomes smaller than their step height and the aspect ratio of the step height to the width of the diffraction ring zones 271 becomes greater than one. In that case, it will be difficult to pattern the material into the intended shape.

Optionally, multiple surfaces may have the diffraction grating 252. In that case, the fringed flare light rays 281 can interfere with each other, and the fringes can be reduced, on those surfaces, which is certainly advantageous. Nevertheless, if multiple surfaces had the diffraction grating 252, the diffraction efficiency would decrease on those surfaces and the unnecessary order diffracted light 256 would be produced a lot in the optical system as a whole. That is why in order to ensure first-order diffraction efficiency, only one surface had better have the diffraction grating 252. However, if a number of surfaces, of which the diffraction grating periods agree with each other, are arranged with a very small gap left between them (as in the third embodiment to be described later, for example), then the diffraction efficiency will decrease to approximately the same degree as in a situation where a diffraction grating is provided for only one surface.

It should be noted that if the optical system of this embodiment is used in an image capture device, the effective diameter hₘₐₓ is determined by the stop or the angle of view. If the effective diameter hₘₐₓ is defined, Inequality (3) can be rewritten into the following Inequality (4):

$$k = \frac{( \frac{1}{{P}_{max - 1}} \cdot \frac{{P}_{max - 1} - {P}_{max}}{{P}_{max - 1} \cdot {P}_{max}} )}{( \frac{1}{{P}_{1}} \cdot \frac{{P}_{1} - {P}_{2}}{{P}_{1} \cdot {P}_{2}} )} > 1.6 \qquad ( 4 )$$

In Inequality (4), Pₘₐₓ represents the width of the diffraction ring zone at the position of the effective diameter hₘₐₓ on the diffraction surface and Pₘₐₓ₋₁ represents the width of the diffraction ring zone that is one step closer to the optical axis than the position of the effective diameter hₘₐₓ is on the diffraction surface. As shown in FIG. 1, a diffraction grating lens may sometimes be provided with several diffraction ring zones outside of the effective diameter hₘₐₓ.

Also, Inequality (3) can also be rewritten into the following Inequality (11):

$$k = \frac{( \frac{1}{{P}_{m - 1}} \cdot \frac{{P}_{m - 1} - {P}_{m}}{{P}_{m - 1} \cdot {P}_{m}} )}{( \frac{1}{{P}_{n - 1}} \cdot \frac{{P}_{n - 1} - {P}_{n}}{{P}_{n - 1} \cdot {P}_{n}} )} > 1.6 \qquad ( 11 )$$

If Inequality (3) is rewritten into Inequality (11), at least one set of m and n needs to satisfy Inequality (11) according to this embodiment.

In Inequality (11), Pₙ represents the width of the n^{th} diffraction ring zone as counted from the one that is located closest to the optical axis, Pₙ₋₁ represents the width of the (n−1)^{th} diffraction ring zone, Pₘ represents the width of the m^{th} diffraction ring zone as counted from the one that is located closest to the center of the diffraction surface, Pₘ₋₁ represents the width of the (m−1)^{th} diffraction ring zone as counted from the one that is located closest to the center of the diffraction surface, and n is an integer that is smaller than m.

The diffraction ring zones 271 had better have a minimum ring zone pitch of 10 μm or more. This is because if the minimum ring zone is 10 μm or more, the diffraction ring zones can be patterned relatively easily. And if the minimum ring zone pitch is 15 μm or more, the patterning process can get done even more easily.

Meanwhile, the minimum ring zone pitch of the diffraction ring zones 271 had better be at most 30 μm. If the number of diffraction ring zones 271 provided within the effective diameter were too small, the effect of canceling the fringed flare light 281 through interference would decrease. However, if the minimum ring zone pitch is 30 μm or less, the number of the diffraction ring zones 271 provided can be the minimum required one to achieve that effect. And if the minimum ring zone pitch is 20 μm or less, the effect of canceling the fringed flare light 281 through interference can be achieved even more significantly.

Hereinafter, a method for designing a diffraction grating lens according to this embodiment will be described. FIG. 7 is a flowchart showing how to design a diffraction grating lens according to this embodiment. First of all, in Step #1, the respective widths of multiple diffraction ring zones of the diffraction grating 252 are determined for an imaging optical system including the diffraction grating. As already described with reference to FIG. 30(b), the diffraction ring zones are arranged every time the phase increases by 2 π in the phase function φ(r). Once the gradient of the phase function φ(r) (representing the coefficient value of the phase function) is determined, the widths of the diffraction ring zones are also determined.

Next, in Step #2, with the phase function fixed, the aspheric coefficient of its diffractive surface is optimized and determined.

The following Equation (12) represents a rotationally symmetric aspheric shape. In this Step #2, the coefficient Ai of Equation (12) needs to be determined.

$$\begin{matrix}c = 1 / r & ( 12 ) \\ h = {( {x}^{2} + {y}^{2} )}^{1 / 2} \\ z = \frac{{ch}^{2}}{1 + {\{ 1 - ( k + 1 ) {c}^{2} {h}^{2} \}}^{1 / 2}} + {A}_{4} {h}^{4} + {A}_{6} {h}^{6} + {A}_{8} {h}^{8} + {A}_{10} {h}^{10} & \end{matrix}$$

In Equation (12), c represents the paraxial curvature, r represents the paraxial radius of curvature, h represents the distance from the axis of rotational symmetry, z represents the SAG of the aspheric surface (i.e., the distance from an xy plane to the aspheric surface), k represents the constant of the cone, and Ai represents a high-order aspheric coefficient.

According to this method, only the phase function can be determined independently in Step #1. Specifically, in Step #1, the widths of the diffraction ring zones can be set so as to fall within a range that makes the patterning process easy and to reduce the fringed flare light. Next, in Step #2, the aspheric coefficient can be determined with the widths of the diffraction ring zones that have been obtained in the previous Step #1 unchanged. As a result, a diffraction grating lens that will produce little fringed flare light and that can be formed easily through a patterning process can be designed.

To reduce the fringed flare light effectively, the respective widths of the plurality of diffraction ring zones had better be made uneven in Step #1.

Hereinafter, a specific method for making the widths of those diffraction ring zones uneven will be described.

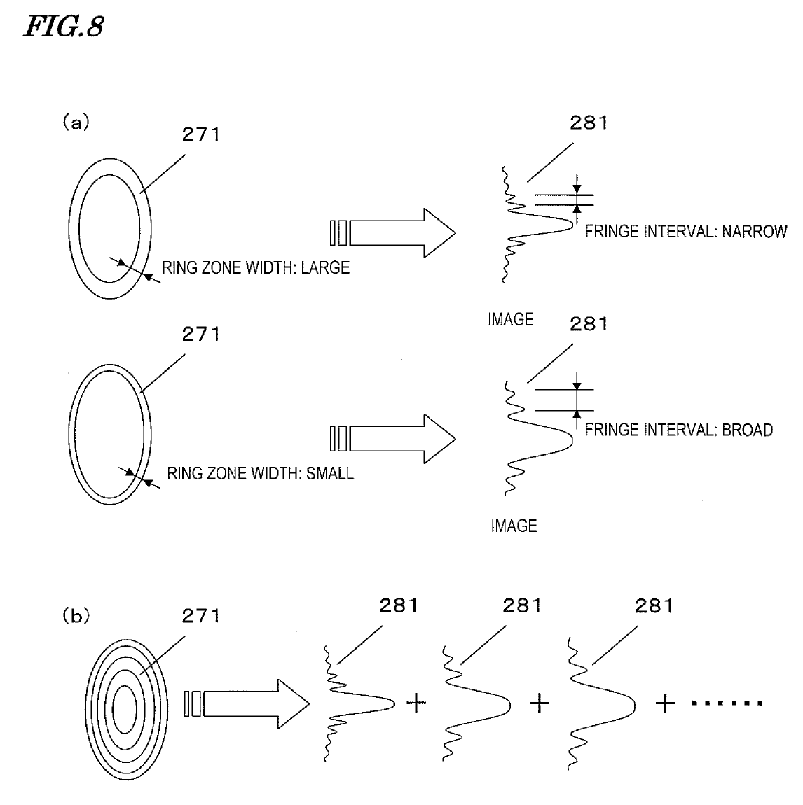

As shown in FIG. 8(a), the fringed flare light 281 produced from a diffraction ring zone 271 is fringed flare, of which the intensity steeply rises and falls to form a bright and dark pattern, as discovered by the present inventors. The interval of the fringes of the fringed flare light 281 produced from the diffraction ring zone 271 is inversely proportional to the width of that diffraction ring zone 271. That is to say, if the width of the diffraction ring zone 271 is increased, the interval of the fringes of the fringed flare light 281 narrows. On the other hand, if the width of the diffraction ring zone 271 is decreased, the interval of the fringes of the fringed flare light 281 broadens. As shown in FIG. 8(b), the image produced on a field by a diffraction grating lens with multiple diffraction ring zones 271 becomes a superposition of multiple fringed flare light rays 281 that have been produced from the respective diffraction ring zones 271. That is why if those diffraction ring zones 271 had a constant width, then the fringed flare light rays 281 would be produced at the same interval and the bright and dark pattern representing the intensity would be amplified. However, if the widths of the diffraction ring zones are made uneven, the flare light rays 281 produced from the respective diffraction ring zones 271 within the effective diameter can interfere with each other. As a result, the bright and dark contrast of the fringed flare light 281 produced from the overall diffraction grating lens can be reduced.

Specifically, this Step #1 includes the respective processing steps shown in FIG. 9.

The width of the diffraction ring zone may be determined in the following manner. First of all, the width of the diffraction ring zone 271 is set provisionally (in Step 1-(1)). In this processing step, while adjusting (or fitting) the coefficients of the phase function equation (1), the distance from the optical axis to the ring zone position (i.e., the radius) is obtained. And based on that distance from the optical axis to the ring zone position, the width of the diffraction ring zone may be determined. When a Fraunhofer diffraction image needs to be obtained, an appropriate value for the diffraction grating lens being designed may be used as the propagation distance.

In Step 1-(1), the widths of the diffraction ring zones are made uneven.

The present inventors discovered via experiments that in a known diffraction grating lens, some of the diffraction ring zones on the diffractive surface, which are located relatively distant from the optical axis, in particular, tend to have an equal width often. In this embodiment, by making the widths of the diffraction ring zones uneven in Step #1, a diffraction grating lens that will produce little fringed flare light can be designed.

In this description, “to make the widths of the diffraction ring zones uneven” refers herein to a situation where the diffraction ring zones that satisfy the phase function equation are generally uneven. According to the present invention, those diffraction ring zones that are located relatively distant from the optical axis (e.g., 80% of the diffraction ring zones that satisfy the phase function equation), in particular, suitably have uneven widths. For example, even if two adjacent diffraction ring zones happen to have an equal width but if the majority of adjacent diffraction ring zones have mutually different widths as a whole, it can still be said that “the widths of the diffraction ring zones are uneven”.

Next, the Fraunhofer diffraction images produced from those diffraction ring zones 271 are obtained (in Step 1-(2)).

Subsequently, by superposing those Fraunhofer diffraction images thus obtained one upon the other, the overall intensity of the fringed flare light 281 produced from the entire surface of the diffraction grating 252 is estimated (in Step 1-(3)). Then, based on this fringed flare light 281, the phase function (representing the widths of the diffraction ring zones) is fixed (in Step 1-(4)).

Specifically, in Step l-(4), the intensity of the fringed flare light 281 that has been estimated in the previous Step 1-(3) is compared to a reference intensity of the fringed flare light 281. And if the estimated intensity of the fringed flare light 281 falls within a permissible range, then that phase function may be adopted. Alternatively, this series of processing steps 1-(1) through 1-(3) may be carried out a number of times to estimate the intensity of the fringed flare light 281 over and over again. And a phase function that has resulted in the fringed flare light 281 with a lower intensity than any other time may be adopted. By optimizing the phase function in advance in this manner, the flare light can be reduced more easily than in a situation where the phase function and the aspheric coefficient are optimized at the same time. On top of that, it is also possible to avoid an unwanted situation where the widths of the diffraction ring zones become too narrow to pattern the material for the diffraction grating lens into the intended shape.

Optionally, if the widths of the diffraction ring zones 271 have been determined in advance in Step 1-(1) by changing the coefficients of the phase function and changing the width of the diffraction ring zone 271 into various values, then there is no need to fix the phase function in step 1-(4) by fitting the phase function equation.

In this case, what needs to be done by the diffraction grating 252 is chromatic aberration correction. That is why in determining the width of the diffraction ring zone 271 (represented by the coefficient of the phase function), diffraction power, with which the unwanted colors can be erased as required by the optical system, needs to be obtained in advance and then reflected in step 1-(1) to a certain degree. It should be noted that the coefficient of the phase function that determines the diffraction power is a second-order coefficient (i.e., a₂ of Equation (1)) and the range in which the width of the diffraction ring zone 271 may change needs to be defined so that the coefficient of the phase function falls within an intended range.

After the phase function of the diffraction grating has been determined, the aspheric coefficient of that diffractive surface is optimized in the next processing step #2 with the phase function's coefficient value thus determined unchanged. By optimizing the aspheric coefficient, the aberration that has not quite been corrected with the fixed phase function can be corrected. Moreover, the aspheric surface to optimize may include not only the aspheric surface of the diffractive surface but also the surface of an optical system or any other surface as well. Since the width of the diffraction ring zone that has already been determined to reduce the fringed flare light 281 can be maintained by fixing the phase function, the fringed flare light 281 can be reduced irrespective of the aspheric shape. Also, in this case, since the range of the phase function has been adjusted in step 1-(1) to correct the chromatic aberration to a certain degree, the effect of the chromatic aberration correction can be basically maintained. However, if that effect can no longer be achieved sufficiently, then the process may go back to Step #1 to determine the phase function all over again That is to say, these Steps #1 and #2 may be carried out in loops in that case.

In the foregoing description, the width of the diffraction ring zone is supposed to be determined in step 1-(1) by the phase function method. However, a high refractive index method may also be adopted. Or any other method may be used instead as long as the widths of those other diffraction ring zones 271 can be determined.

### Embodiment 2

Next, an embodiment in which the surface of the diffraction grating is covered with an optical adjustment film will be described.

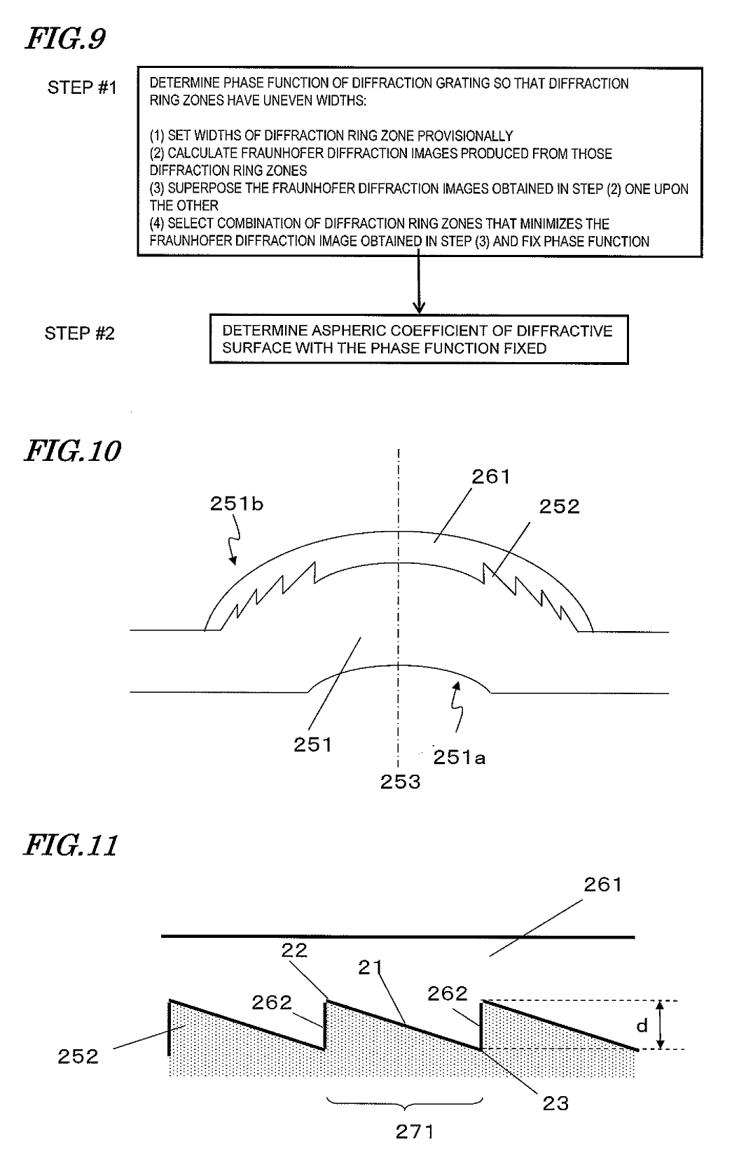

FIG. 10 is a cross-sectional view schematically illustrating a second embodiment of a diffraction grating lens according to the present invention. The diffraction grating lens shown in FIG. 10 further includes an optical adjustment film 261 on the second surface 251b of the diffraction grating 252. In FIG. 10, any component having substantially the same function as its counterpart shown in FIG. 1 will not be described all over again.

As the material for the optical adjustment film 261, a resin, glass, or a composite material of a resin and inorganic particles may be used, for example.

In this embodiment, the height d of the stepped surface 262 satisfies the following Inequality (13):

$$\frac{0.9 {m}_{o} λ}{\vert {n}_{1} ( λ ) - {n}_{2} ( λ ) \vert} \leq d \leq \frac{1.1 {m}_{o} λ}{\vert {n}_{1} ( λ ) - {n}_{2} ( λ ) \vert} \qquad ( 13 )$$

where mₒ is the order of design (e.g., mₒ==1 in the case of the first-order diffracted light), λ is the designed wavelength, n₁(λ) is the refractive index of the material for the lens body at λ, and n₂(λ) is the refractive index of the material for the optical adjustment film at λ. As a result, the flare involved with the unnecessary order diffracted light 256 can be reduced over the entire visible radiation range.

FIG. 11 is an enlarged view of the diffraction grating lens of this embodiment. The diffraction grating 252 includes a plurality of diffraction ring zones 271 and a plurality of stepped surfaces 262. One stepped surface 262 is provided between two adjacent diffraction ring zones 271. Each diffraction ring zone 271 has a sloping surface 21 that slopes in the width direction of that ring zone 271. Also, each stepped surface 262 is connected to the edge 22 of one of the two adjacent sloping surfaces 21 and to the root 23 of the other adjacent sloping surface 21. That is to say, the diffraction ring zone 271 is a ringlike raised portion interposed between two stepped surfaces 262. In this embodiment, the diffraction ring zones 271 are arranged concentrically with respect to the optical axis 253 of the aspheric basic shape of the first and second surface 251a and 251b. The diffraction ring zones 271 do not always have to be arranged concentrically. Nonetheless, in order to improve the aberration property of an optical system for use to capture an image, it is still recommended that the diffraction ring zones 271 be rotationally symmetric with respect to the optical axis 253.

According to this embodiment, the same effects as what is achieved by the first embodiment described above can also be achieved. That is to say, since the diffraction grating 252 has diffraction ring zones that satisfy Inequality (3), generation of fringed flare light can be reduced significantly. In addition, since the optical adjustment film 261 is provided according to this embodiment, the flare involved with the unnecessary order diffracted light 256 can also be reduced over the entire visible radiation range.

### Embodiment 3

Next, an optical element that includes two or more lenses with diffraction grating will be described.

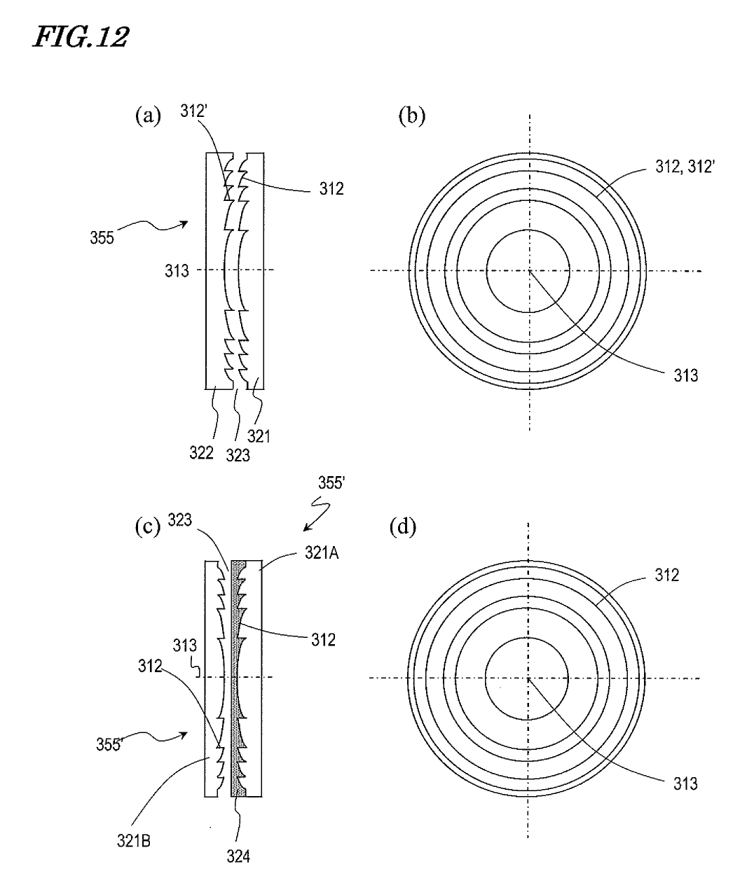

FIGS. 12(a) and 12(b) are respectively a schematic cross-sectional view and a plan view illustrating an embodiment of an optical element according to the present invention. This optical element 355 includes two lenses, each of which has a diffraction grating. Specifically, one of the two lenses includes a body 321 and a diffraction grating 312, which has been formed on one of the two surfaces of the body 321. The other lens includes a body 322 and a diffraction grating 312′, which has been formed on one of the two surfaces of the body 322. These two lenses are held with a predetermined gap 323 left between them. These diffraction gratings 312 and 312′ each have a concentric pattern that is defined with respect to the center 313 at which the optical axis intersects with the lens. These diffraction gratings 312 and 312′ use two different orders of diffraction with mutually opposite signs (i.e., positive and negative) but do use the same phase difference function.

FIGS. 12(c) and 12(d) are respectively a schematic cross-sectional view and a plan view illustrating a modified example of the optical element of this embodiment. This optical element 355′ includes two lenses and an optical adjustment layer 324. Specifically, one of the two lenses includes a body 321A and a diffraction grating 312, which has been formed on one of the two surfaces of the body 321A. The other lens includes a body 321B and a diffraction grating 312, which has been formed on one of the two surfaces of the body 321B. The optical adjustment layer 324 covers the diffraction grating 312 of the body 321A. These two lenses are held with a predetermined gap 323 left between the diffraction grating 312 on the surface of the body 321B and the optical adjustment layer 324. The respective diffraction gratings 312 of the two lenses have the same shape.

According to this embodiment, the same effect as what is achieved by the first embodiment can also be achieved. That is to say, since each of the diffraction gratings 312 and 312′ has the diffraction ring zones that satisfy Inequality (3), generation of fringed flare light can be reduced significantly.

Also, in the optical elements 355 and 355′, a pair of lenses, each having the diffraction grating 312 or 312′, is arranged close to each other, and the two diffraction gratings 312 and 312′ have either the same shape or corresponding shapes. As a result, the two diffraction gratings 312 and 312′ substantially function as a single diffraction grating and contribute to achieving the effects described above without causing a significant decrease in diffraction efficiency.

In any of the simple diffraction grating of the first embodiment with no optical adjustment layer on the surface, the close-contact diffraction grating of the second embodiment with an optical adjustment layer on the surface, and the stacked diffraction grating of the third embodiment, if the diffraction ring zones of the diffraction grating have the same width, then the distribution of the fringed flare light produced will be the same. That is to say, if the diffraction ring zones of the diffraction grating have the same width, the degree of clearness of the fringes will have the same value. This is because in this description, the fringed flare light is produced by the Fraunhofer diffraction phenomenon that is brought about by a diffraction ring zone functioning as a very narrow slit and does not depend on what kind of medium the diffraction grating contacts with. For that reason, in any of the simple, close-contact and stacked diffraction gratings of the first, second and third embodiments, if the ring zones of the diffraction grating satisfy Inequality (3), the generation of the fringed flare light can be minimized.

### Example 1

As a first example, a diffraction grating lens with the following specifications was analyzed. The following Table 1 shows the data of the widths (i.e., pitches) of the diffraction ring zones that the diffraction grating lens representing the first example had. The data shown in the following Table 1 was collected through the effective diameter.

F-number: 2.8,

k value of conditional formula: 2.4, and

degree of clearness of fringes: 9.7×10⁻⁷(9.7e−7)

TABLE 1

| Ring zone # | Ring zone position [mm] | Pitch [mm] |
|---|---|---|
| 1 | 0.180 | 0.180 |
| 2 | 0.250 | 0.071 |
| 3 | 0.303 | 0.053 |
| 4 | 0.347 | 0.043 |
| 5 | 0.384 | 0.038 |
| 6 | 0.418 | 0.034 |
| 7 | 0.449 | 0.031 |
| 8 | 0.477 | 0.029 |
| 9 | 0.504 | 0.027 |
| 10 | 0.530 | 0.025 |
| 11 | 0.554 | 0.024 |
| 12 | 0.577 | 0.023 |
| 13 | 0.600 | 0.022 |
| 14 | 0.621 | 0.022 |
| 15 | 0.642 | 0.021 |
| 16 | 0.662 | 0.020 |
| 17 | 0.682 | 0.020 |
| 18 | 0.701 | 0.019 |
| 19 | 0.719 | 0.018 |
| 20 | 0.736 | 0.018 |

FIG. 13 shows a cross-sectional intensity distribution of the fringed flare light 281 on the field in this first example. The distribution shown in FIG. 13 was obtained by calculating the Fraunhofer diffraction image produced from the respective diffraction ring zones 271 of the first example and superposing them one upon the other. It can be seen that in this first example, Inequality (3) is satisfied and the intensity of the fringed flare light 281 can be reduced as shown in FIG. 13.

### Example 2

As a second example, a diffraction grating lens with the following specifications was analyzed. The following Table 2 shows the data of the widths (i.e., pitches) of the diffraction ring zones that the diffraction grating lens representing the second example had. The data shown in the following Table 2 was collected through the effective diameter.

F-number: 2.8,

k value of conditional formula: 2.5, and

degree of clearness of fringes: 8.0×10⁻⁷ (8.0e−7)

TABLE 2

| Ring zone # | Ring zone position [mm] | Pitch [mm] |
|---|---|---|
| 1 | 0.162 | 0.162 |
| 2 | 0.228 | 0.066 |
| 3 | 0.279 | 0.051 |
| 4 | 0.321 | 0.043 |
| 5 | 0.359 | 0.038 |
| 6 | 0.393 | 0.034 |
| 7 | 0.425 | 0.032 |
| 8 | 0.454 | 0.030 |
| 9 | 0.482 | 0.028 |
| 10 | 0.509 | 0.027 |
| 11 | 0.534 | 0.026 |
| 12 | 0.559 | 0.025 |
| 13 | 0.583 | 0.024 |
| 14 | 0.605 | 0.023 |
| 15 | 0.628 | 0.022 |
| 16 | 0.649 | 0.021 |
| 17 | 0.669 | 0.020 |
| 18 | 0.689 | 0.020 |
| 19 | 0.708 | 0.019 |
| 20 | 0.726 | 0.018 |

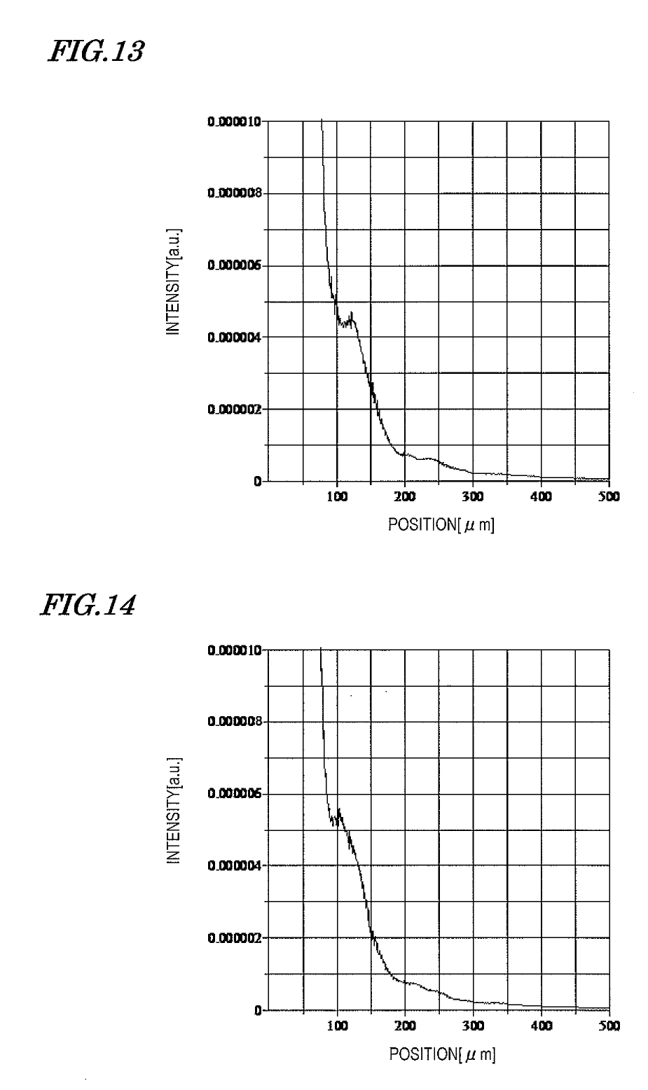

FIG. 14 shows a cross-sectional intensity distribution of the fringed flare light 281 on the field in this second example. In FIG. 14, the analysis was made by the same method as what has already been described for the first example. It can be seen that in this second example, Inequality (3) is also satisfied and the intensity of the fringed flare light 281 can also be reduced as shown in FIG. 14.

### Example 3

As a third example, a diffraction grating lens with the following specifications was analyzed. The following Table 3 shows the data of the widths (i.e., pitches) of the diffraction ring zones that the diffraction grating lens representing the third example had. The data shown in the following Table 3 was collected through the effective diameter.

F-number: 2.8,

k value of conditional formula: 4.2, and

degree of clearness of fringes: 8.3×10⁻⁷ (8.3e−7)

TABLE 3

| Ring zone # | Ring zone position [mm] | Pitch [mm] |
|---|---|---|
| 1 | 0.159 | 0.159 |
| 2 | 0.225 | 0.066 |
| 3 | 0.276 | 0.051 |
| 4 | 0.319 | 0.043 |
| 5 | 0.358 | 0.039 |
| 6 | 0.393 | 0.035 |
| 7 | 0.426 | 0.033 |
| 8 | 0.458 | 0.031 |
| 9 | 0.488 | 0.030 |
| 10 | 0.516 | 0.029 |
| 11 | 0.544 | 0.028 |
| 12 | 0.570 | 0.026 |
| 13 | 0.596 | 0.025 |
| 14 | 0.620 | 0.024 |
| 15 | 0.643 | 0.023 |
| 16 | 0.665 | 0.022 |
| 17 | 0.686 | 0.021 |
| 18 | 0.705 | 0.019 |
| 19 | 0.723 | 0.018 |
| 20 | 0.740 | 0.017 |

FIG. 15 shows a cross-sectional intensity distribution of the fringed flare light 281 on the field in this third example. In FIG. 15, the analysis was made by the same method as what has already been described for the first example. It can be seen that in this third example, Inequality (3) is also satisfied and the intensity of the fringed flare light 281 can also be reduced as shown in FIG. 15.

### Comparative Example 1

As a first comparative example, a diffraction grating lens with the following specifications was analyzed. The following Table 4 shows the data of the widths (i.e., pitches) of the diffraction ring zones that the diffraction grating lens representing the first comparative example had. The data shown in the following Table 4 was collected through the effective diameter.

F-number: 2.8,

k value of conditional formula: 0.070, and

degree of clearness of fringes: 2.2)(10⁻⁶ (2.2e−6)

TABLE 4

| Ring zone # | Ring zone position [mm] | Pitch [mm] |
|---|---|---|
| 1 | 0.141 | 0.141 |
| 2 | 0.199 | 0.058 |
| 3 | 0.243 | 0.044 |
| 4 | 0.280 | 0.037 |
| 5 | 0.313 | 0.033 |
| 6 | 0.343 | 0.030 |
| 7 | 0.370 | 0.027 |
| 8 | 0.396 | 0.026 |
| 9 | 0.420 | 0.024 |
| 10 | 0.443 | 0.023 |
| 11 | 0.465 | 0.022 |
| 12 | 0.486 | 0.021 |
| 13 | 0.507 | 0.021 |
| 14 | 0.527 | 0.020 |
| 15 | 0.547 | 0.020 |
| 16 | 0.566 | 0.019 |
| 17 | 0.585 | 0.019 |
| 18 | 0.604 | 0.019 |
| 19 | 0.622 | 0.018 |
| 20 | 0.640 | 0.018 |
| 21 | 0.658 | 0.018 |
| 22 | 0.677 | 0.018 |
| 23 | 0.694 | 0.018 |
| 24 | 0.712 | 0.018 |
| 25 | 0.730 | 0.018 |

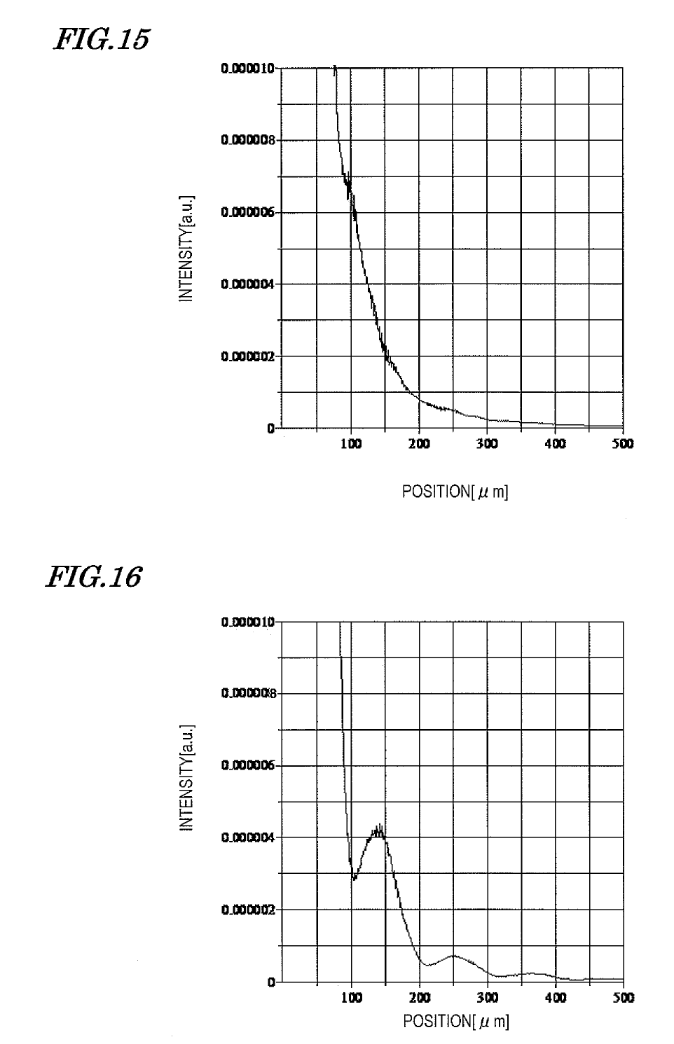

FIG. 16 shows a cross-sectional intensity distribution of the fringed flare light 281 on the field in this first comparative example. In FIG. 16, the analysis was made by the same method as what has already been described for the first example. It can be seen that in this first comparative example, Inequality (3) is not satisfied and the fringes of the fringed flare light 281 are sensible clearly as shown in FIG. 16.

As described above, if the diffraction ring zones of a diffraction grating have the same width, the fringed flare light produced will have the same distribution. The results of analysis on the degree of clearness of the fringes were obtained in the first through fourth examples and in the first comparative example by defining the widths (or pitches) of the diffraction ring zones. That is why these results are applicable to any of the simple diffraction grating, the close-contact diffraction grating, and the stacked diffraction grating.

### Embodiment 4

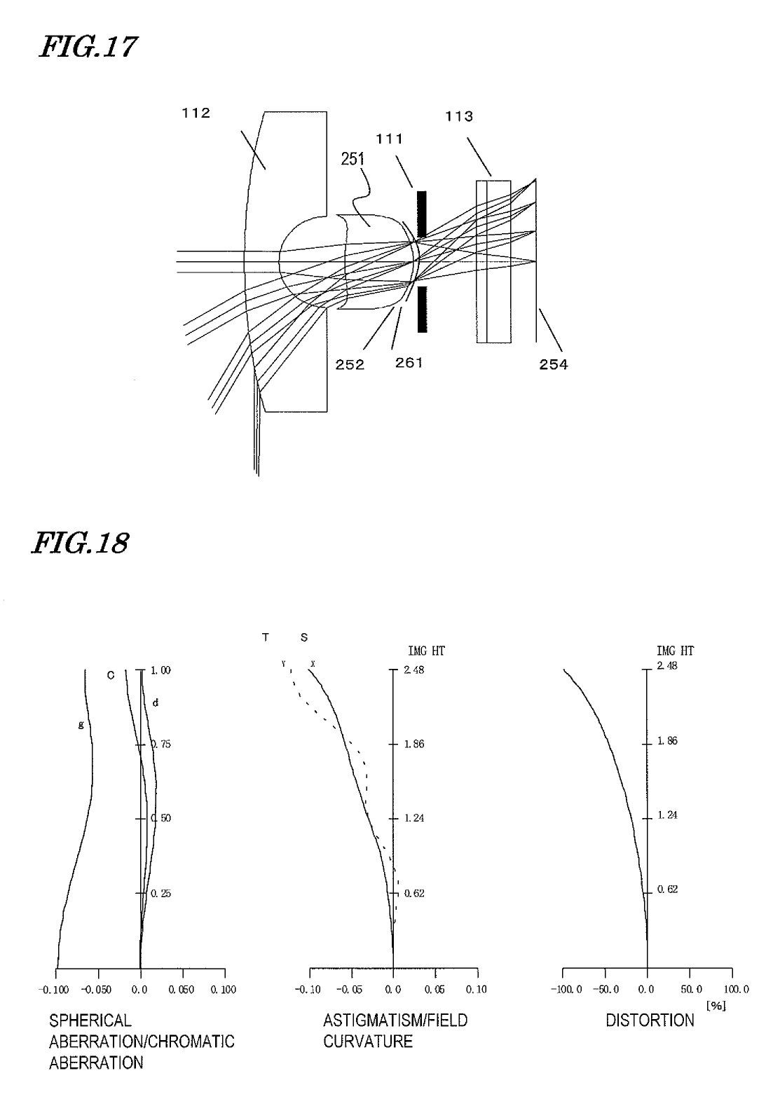

Hereinafter, an imaging optical system that uses the diffraction grating lens of the first, second or third embodiment will be described. FIG. 17 is a cross-sectional view schematically illustrating an embodiment of an imaging optical system according to the present invention. As shown in FIG. 17, the imaging optical system of this embodiment includes a meniscus concave lens 112, a diffraction grating lens (functioning as a lens body) 251, a stop 111, a cover glass and filter 113, and an image sensor 254. The stop 111 is arranged to face the diffraction surface of the diffraction grating lens 251.

In this embodiment, the diffraction grating lens 251 of the second embodiment is used and has its surface (i.e., the second surface 251b shown in FIG. 10) covered with an optical adjustment film 261 that satisfies Inequality (13). Optionally, the diffraction grating lens 251 of the second embodiment for use in this embodiment may be replaced with the diffraction grating lens 251 of the first embodiment or the optical element 355 or 355′ of the third embodiment.

The light that has entered the imaging optical system of this embodiment is condensed by the meniscus concave lens 112 first and incident on the diffraction grating lens 251. The light that has been incident on the diffraction grating lens 251 is transmitted through the diffraction grating lens 251, passes through the stop 111 and the cover glass and filter 113, and then reaches the image sensor 254.

Although the meniscus concave lens 112 is used as an additional optical lens besides the diffraction grating lens, any other spherical or aspheric lens may also be used. Or both a spherical lens and an aspheric lens could be used at the same time. Furthermore, the number of lenses used does not have to be one but may also be plural.

The surface with the diffraction grating 252 had better be one of the lens surfaces of this imaging optical system that is located closest to the stop 113 (i.e., arranged in the closest proximity to the stop 113). However, a non-lens member could be interposed between the diffraction grating 252 and the stop 113. By adopting such an arrangement, the effective area on the diffractive surface becomes substantially the same at any angle of view. As a result, the flare reduction effect will depend much less on the angle of view. Also, if the stop 113 were located far away from the diffractive surface, the arc lengths of the respective ring zones would become non-uniform within the effective area as shown in FIG. 35, and so would those of the fringes generated. As a result, the fringed flare light 281 would be likely to persist and should be hard to eliminate. On the other hand, if the diffractive surface is arranged in the vicinity of the stop, each of the ring zones will have a doughnut shape, i.e., will form a perfect ring, within the effective area. In that case, the fringes generated will also have a doughnut shape, and therefore, the fringed flare light 281 can be reduced effectively by combining such ring zones and fringes together.

Also, the imaging optical system of this fourth embodiment may be set up to correct the axial chromatic aberration slightly insufficiently. Specifically, the back focus of a C line may be longer than that of a g line. This is because if the imaging optical system tried to satisfy Inequality (3) while correcting the axial chromatic aberration perfectly, then the diffraction ring zones would tend to have decreased widths in the vicinity of the effective diameter and it would be difficult to get the patterning process done as intended. To satisfy Inequality (3) without decreasing the widths of the diffraction ring zones, the diffraction ring zone may have somewhat broader widths over the entire effective area (i.e., the power by diffraction may be decreased to a certain degree). If the diffraction power is lowered to a certain degree, then the axial chromatic aberration will be corrected slightly insufficiently.

Also, the configurations of the first through fourth embodiments would be applicable more effectively to a super-wide angle optical system for the following reason. Specifically, the larger the angle of view, the larger the angle of incidence of a light ray on the diffraction grating 252 (i.e., the tilt angle with respect to the optical axis). That is why the ratio of the quantity of the light incident on the stepped surface 262 to that of the light incident on the ring zone slope 21 increases. As a result, in a super-wide angle optical system, the light ray passing through the ring zone slope 21 will have a narrower width than in a normal optical system. Consequently, the quantity of the fringed flare light 281 increases more steeply than that of the main spot light, and the fringed flare light 281 will cause a more serious problem in that case.

### Example 4

As a fourth example, the imaging optical system shown in FIG. 17 was analyzed. This fourth example is a two-lens imaging optical system, which is obtained by adding a meniscus concave lens 112 to the diffraction grating lens of the first example. In this embodiment, a single diffraction grating lens, of which the surface was covered with an optical adjustment film, (i.e., a close-contact type diffraction grating lens) was used. The diffraction grating 252 of the diffraction grating lens was covered with an optical adjustment film 261 that satisfies Equation (13), thereby reducing the unnecessary order diffracted light 256. Also, the stop 111 was arranged to face the diffractive surface of the diffraction grating lens 251. Following are the specifications of this fourth example. The data about the widths of the diffraction ring zones and the k value of the conditional formula are the same as those of the first example described above:

F-number: 2.8,

Full angle of view: 180 degrees, and

d: 15 μm

FIG. 18 shows the aberrations involved with this fourth example. As can be seen from the spherical aberration diagram, the back focus of a C line was longer than that of a g line. By adopting such a configuration, the diffraction ring zones were still wide enough to be patterned with Inequality (3) satisfied.

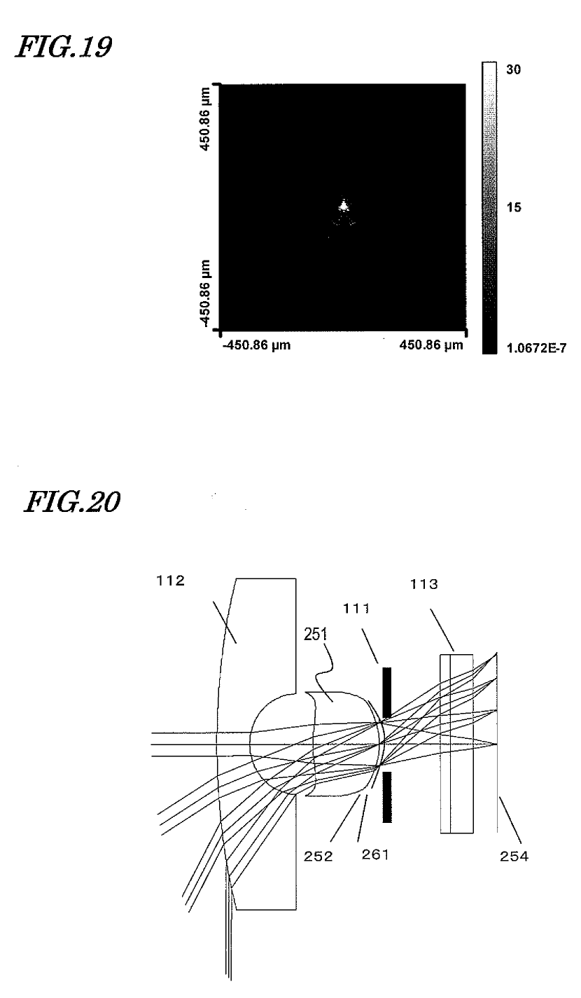

FIG. 19 shows the distribution of intensities of a spot that was formed by a light ray with a wavelength of 640 nm that passed through the optical system of the fourth example at an angle of view of 60 deg (i.e., at a full angle of view of 120 deg). The results shown in FIG. 19 were affected by not only the fringed flare light 281 but also the unnecessary order diffracted light 256 and the optical system's aberrations as well. It can be confirmed based on the results shown in FIG. 19 that the fringed flare light 281 could be reduced.

### Example 5

FIG. 20 illustrates an imaging optical system as a fifth example. This fifth example is a two-lens imaging optical system, which is obtained by adding a meniscus concave lens 112 to the diffraction grating lens of the second example. In this embodiment, a single diffraction grating lens, of which the surface was covered with an optical adjustment film, (i.e., a close-contact type diffraction grating lens) was used. The diffraction grating 252 of the diffraction grating lens was covered with an optical adjustment film 261 that satisfies Equation (13), thereby reducing the unnecessary order diffracted light 256. Also, the stop 111 was arranged to face the diffractive surface of the diffraction grating lens 251. Following are the specifications of this fourth example. The data about the widths of the diffraction ring zones and the k value of the conditional formula are the same as those of the first example described above:

F-number: 2.8,

Full angle of view: 180 degrees, and

d: 15 μm

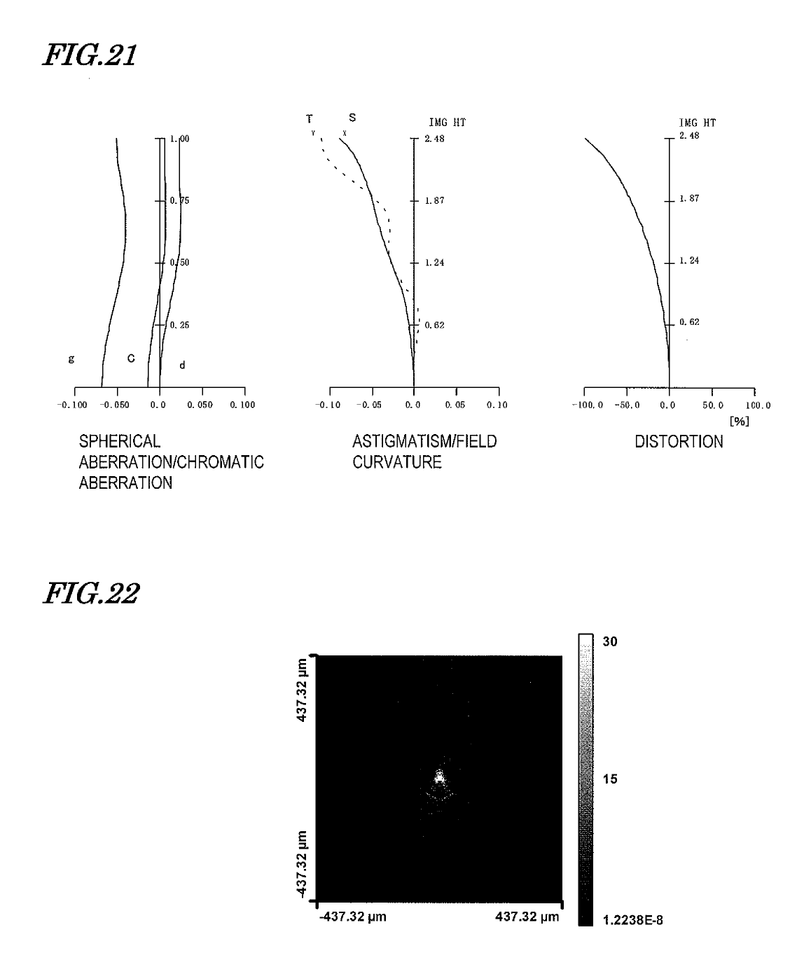

FIG. 21 shows the aberrations involved with this fifth example. As can be seen from the spherical aberration diagram, the back focus of a C line was longer than that of a g line. By adopting such a configuration, the diffraction ring zones were still wide enough to be patterned with Inequality (3) satisfied. FIG. 22 shows the distribution of intensities of a spot that was formed by a light ray with a wavelength of 640 nm that passed through the optical system of the fifth example at an angle of view of 60 deg (i.e., at a full angle of view of 120 deg). The results shown in FIG. 22 were affected by not only the fringed flare light 281 but also the unnecessary order diffracted light 256 and the optical system's aberrations as well. It can be confirmed based on the results shown in FIG. 22 that the fringed flare light 281 could be reduced.

### Example 6

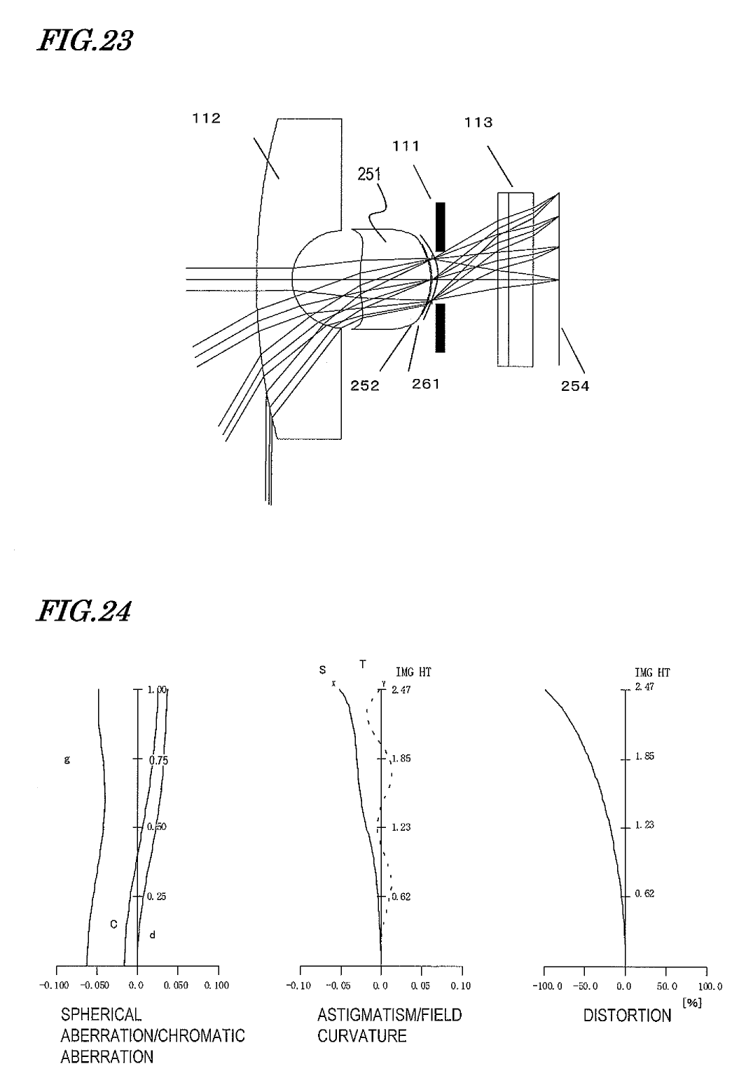

FIG. 23 illustrates an imaging optical system as a sixth example. This sixth example is a two-lens imaging optical system, which is obtained by adding a meniscus concave lens 112 to the diffraction grating lens of the third example. In this embodiment, a single diffraction grating lens, of which the surface was covered with an optical adjustment film, (i.e., a close-contact type diffraction grating lens) was used. The diffraction grating 252 of the diffraction grating lens was covered with an optical adjustment film 261 that satisfies Equation (13), thereby reducing the unnecessary order diffracted light 256. Also, the stop 111 was arranged to face the diffractive surface of the diffraction grating lens 251. Following are the specifications of this sixth example. The data about the widths of the diffraction ring zones and the k value of the conditional formula are the same as those of the third example described above:

F-number: 2.8,

Full angle of view: 180 degrees, and

d: 15 μm

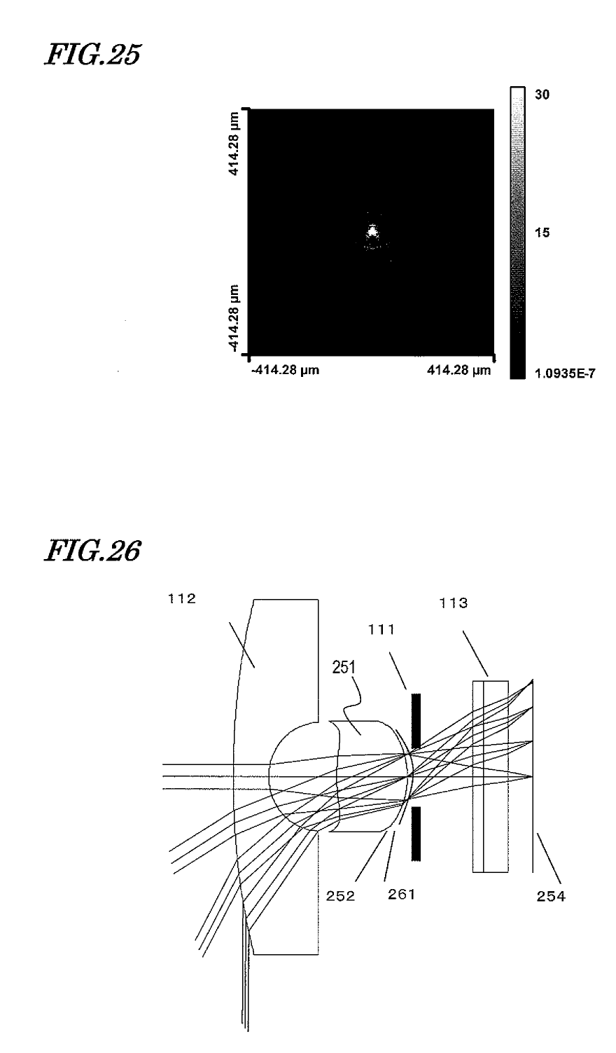

FIG. 24 shows the aberrations involved with this sixth example. As can be seen from the spherical aberration diagram, the back focus of a C line was longer than that of a g line. By adopting such a configuration, the diffraction ring zones were still wide enough to be patterned with Inequality (3) satisfied. FIG. 25 shows the distribution of intensities of a spot that was formed by a light ray with a wavelength of 640 nm that passed through the optical system of the sixth example at an angle of view of 60 deg (i.e., at a full angle of view of 120 deg). The results shown in FIG. 25 were affected by not only the fringed flare light 281 but also the unnecessary order diffracted light 256 and the optical system's aberrations as well. It can be confirmed based on the results shown in FIG. 25 that the fringed flare light 281 could be reduced.

### Comparative Example 2

FIG. 26 illustrates an imaging optical system as a second comparative example. This second comparative example is a two-lens imaging optical system, which is obtained by adding a meniscus concave lens 112 to the diffraction grating lens of the first comparative example. The diffraction grating 252 of the diffraction grating lens was covered with an optical adjustment film 261 that satisfies Equation (13), thereby reducing the unnecessary order diffracted light 256.

Also, the stop 111 was arranged to face the diffractive surface of the diffraction grating lens 251. Following are the specifications of this second comparative example. The data about the widths of the diffraction ring zones and the k value of the conditional formula are the same as those of the first comparative example described above:

F-number: 2.8,

Full angle of view: 180 degrees, and

d: 15 μm

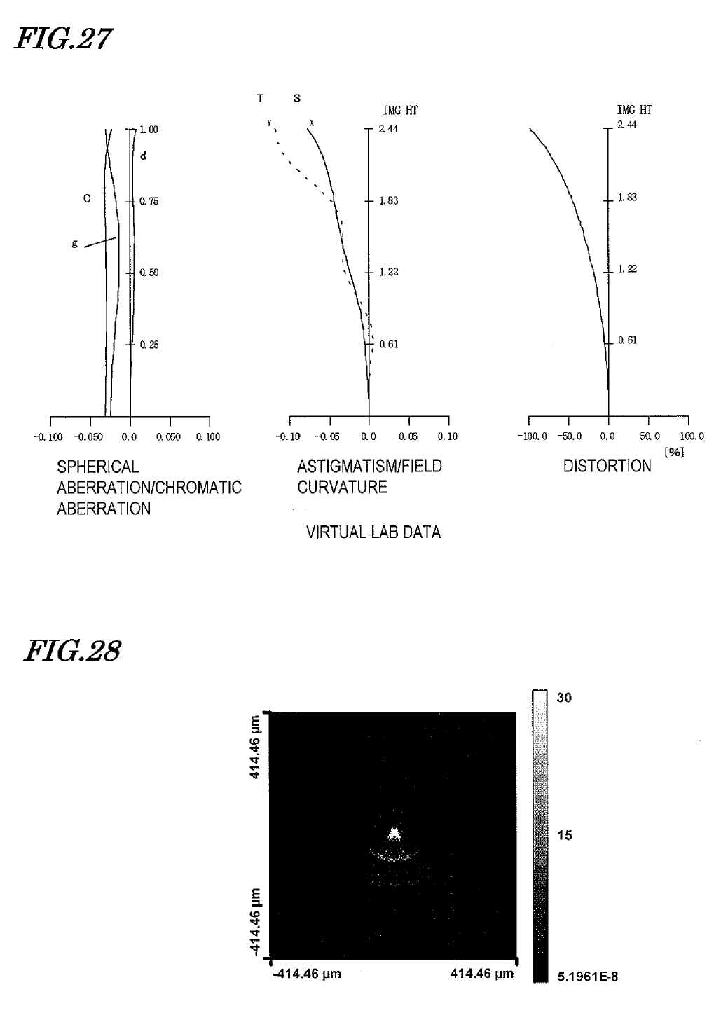

FIG. 27 shows the aberrations involved with this second comparative example. As can be seen from the spherical aberration diagram, the back focus of a C line was longer than that of a g line. FIG. 28 shows the distribution of intensities of a spot that was formed by a light ray with a wavelength of 640 nm that passed through the optical system of the second comparative example at an angle of view of 60 deg (i.e., at a full angle of view of 120 deg). The results shown in FIG. 28 were affected by not only the fringed flare light 281 but also the unnecessary order diffracted light 256 and the optical system's aberrations as well. It can be confirmed based on the results shown in FIG. 28 that the fringed flare light 281 was produced.

As described above, if the diffraction ring zones of the diffraction grating have the same width, then the distribution of the fringed flare light produced will be the same. The results of analysis described for the fourth through sixth examples and the second comparative example were obtained using a close-contact diffraction grating lens. However, even with the simple or stacked diffraction grating lens used, if the widths of the diffraction ring zones also satisfy Inequality (3), the fringed flare light 281 can be reduced to a degree of clearness of the fringes of 10⁻⁶ mm⁻² or less. On the other hand, unless Inequality (3) is satisfied, the fringed flare light 281 will be produced noticeably to a degree of clearness of the fringes of more than 10⁻⁶ mm⁻².

### Embodiment 5

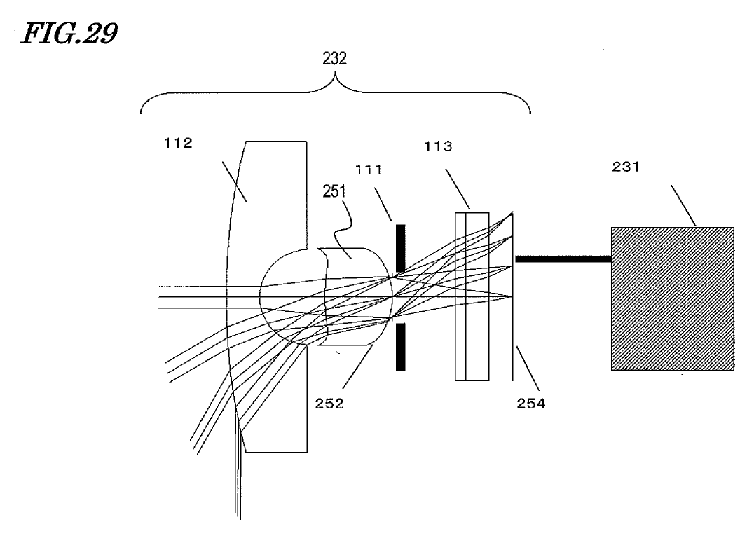

Hereinafter, an image capture device including an imaging optical system as a fifth embodiment will be described. FIG. 29 is a cross-sectional view schematically illustrating an embodiment of an image capture device according to the present invention. The image capture device of this fifth embodiment includes the imaging optical system 232 of the fourth embodiment and an image processor 231. Optionally, the image capture device of this embodiment may further include a spherical lens or an aspheric lens as well as the diffraction grating lens. Also, the number of such an additional lens to provide along with the diffraction grating lens does not have to be one but may also be plural. In order to reduce the fringed flare light 281 effectively, the stop 111 had better be arranged in the vicinity of the diffraction grating 252. The image processor 231 performs various kinds of processing, including gain adjustment, exposure time adjustment, noise reduction, sharpness control, color correction, white balance adjustment, and distortion correction, on the image that has been obtained through the optical system. Optionally, the image processor 231 may also perform the processing of removing the flare light that remains even after having passed through the diffraction grating lens of the present invention.

### INDUSTRIAL APPLICABILITY

A diffraction grating lens according to the present invention and an imaging optical system and image capture device using such a lens have the capability to reduce the fringed flare light, thus contributing to providing a camera of quality, among other things.

### REFERENCE SIGNS LIST

21 sloping surface
22 edge
23 root
24 wavefront bypassing phenomenon
111 stop
112 meniscus concave lens
113 cover glass and filter
231 image processor
232 imaging optical system
241 step height
251 lens body (diffraction grating lens)
252 diffraction grating
253 optical axis
254 image sensor
255 first-order diffracted light
256 unnecessary order diffracted light
261 optical adjustment film
262 stepped surface
271 diffraction ring zone
281 fringed flare light
312, 312′ diffraction grating
313 intersection between optical axis and lens
321, 321A, 321B body
322 body
323 gap
324 optical adjustment layer
355, 355′ optical element

1. An imaging optical system comprising:
at least one diffraction grating lens with a diffraction grating that is made up of q diffraction ring zones; and
a stop,
wherein a surface of the at least one diffraction grating lens that has the diffraction grating is a lens surface that is located closest to the stop, and
wherein supposing the respective widths of diffraction ring zones that are located first, second, (m−1)^{th} and m^{th} closest to the optical axis of the optical system are identified by P₁, P₂, Pₘ₋₁ and Pₘ, at least one m that falls within the range 3<m≦q satisfies the following Inequality (3):
$$k = \frac{( \frac{1}{{P}_{m - 1}} \cdot \frac{{P}_{m - 1} - {P}_{m}}{{P}_{m - 1} \cdot {P}_{m}} )}{( \frac{1}{{P}_{1}} \cdot \frac{{P}_{1} - {P}_{2}}{{P}_{1} \cdot {P}_{2}} )} > 1.6 \qquad ( 3 )$$

2. The imaging optical system of claim 1, wherein if the width of a diffraction ring zone that is located at a position with an effective diameter hₘₐₓ is Pₘₐₓ and if the width of another diffraction ring zone that is one zone closer to the optical axis than the position with the effective diameter hₘₐₓ is Pₘₐₓ₋₁, the following Inequality (4)
$$k = \frac{( \frac{1}{{P}_{max - 1}} \cdot \frac{{P}_{max - 1} - {P}_{max}}{{P}_{max - 1} \cdot {P}_{max}} )}{( \frac{1}{{P}_{1}} \cdot \frac{{P}_{1} - {P}_{2}}{{P}_{1} \cdot {P}_{2}} )} > 1.6 \qquad ( 4 )$$
is satisfied.

3. The imaging optical system of claim 1, further comprising either a spherical lens or an aspheric lens.

4. The imaging optical system of claim 1, further comprising an optical adjustment layer that has been formed on the surface with the diffraction grating.

5. The imaging optical system of claim 1, wherein the diffraction grating has been formed on only one surface of the at least one diffraction grating lens.

6. The imaging optical system of claim 1, wherein at least one diffraction grating lens comprises multiple diffraction grating lenses.

7. An image capture device comprising:
the imaging optical system of claim 1;
an image sensor; and
an image processor.
